(19) United States
(12) Patent Application Publication
(10) Pub. No.: US 2013/0094617 A1
(43) Pub. Date: Apr. 18, 2013

(54) DIGITAL BROADCAST RECEIVER APPARATUS AND DIGITAL BROADCAST RECEPTION METHOD

(71) Applicants: Takatoshi Shirosugi, Chigasaki (JP); Shinichi Murakami, Yokohama (JP)

(72) Inventors: Takatoshi Shirosugi, Chigasaki (JP); Shinichi Murakami, Yokohama (JP)

(21) Appl. No.: 13/696,624

(22) PCT Filed: Feb. 28, 2011
(86) PCT No.: PCT/JP2011/054506

§ 371 Date: Dec. 21, 2012

(30) Foreign Application Priority Data
May 10, 2010 (JP) 2010-107856
May 10, 2010 (JP) 2010-107857

(51) Int. Cl. H04L 27/26

(52) U.S. Cl. CPC H04L 27/2647
USPC 375/340

(57) ABSTRACT

This invention provides detailed operations of a transmitter apparatus and a receiver apparatus that are capable of reproducing, possibly without delays, up-to-the minute earthquake reports conveyed via digital broadcasts. There are included a receiving unit for receiving the conveyed signal; a broadcast modulating unit for demodulating the digital broadcast signal from the conveyed signal received by the receiving unit; an emergency alarm broadcast activation flag detecting unit for detecting the emergency alarm broadcast activation flag from the conveyed signal received by the receiving unit; and an earthquake movement alarm information demodulating unit for demodulating the earthquake movement alarm information signal from the conveyed signal received by the receiving unit.

### TECHNICAL FIELD

The present invention relates to a transmission technology and a reception technology of emergency information, which is transferred through a digital broadcast.

### BACKGROUND OF THE INVENTION

Conventionally, under observation of an emergency alarm broadcast activation flag included in a digital broadcast transmission signal, a compulsive exchange of services and/or shift from a waiting condition to a normal electricity supplying condition, etc., when the emergency alarm broadcast activation flag is turned into “1”, enables to provide an emergency alarm broadcast to a viewer/listener, quickly (see [0010] of the Patent Document 1).

### PRIOR ART DOCUMENTS

### Patent Documents

[Patent Document 1] Japanese Patent Laying-Open No. 2005-333512 (2005).

### BRIEF SUMMARY OF THE INVENTION

### Problem(s) to be Dissolved by the Invention

In the Patent Document 1 mentioned above is described a low electric-energy consumption under a standby condition, i.e., observing the emergency alarm broadcast.

However, in the emergency alarm broadcast, which is activated by the emergency alarm broadcast activation flag, an emergency alarm broadcast signal is compressed in coding thereof on a transmitter side, therefore, for reproducing thereof, it is necessary to conduct an expansion decoding process on a receiver side. For this reason, there is generated a delay time for expanding the compression until when the emergency alarm broadcast is reproduced.

The present invention is accomplished by taking such the situation into the consideration thereof, and an object thereof is to provide detailed operations of a transmitter apparatus and a receiver apparatus, being capable of reproducing an up-to-the-minute or emergency earthquake quick report, which is transmitted through the digital broadcast, as quickly as possible.

### Means for Dissolving the Problem(s)

For accomplishing the object mentioned above, for example, such structures are adopted, as will be mentioned in the claims.

### Effect(s) of the Invention

According to the present invention, it is possible to provide the transmitter apparatus and the receiver apparatus, having a transmission method and a reception method for enabling reproduction of the emergency earthquake quick report on the receiver side, as quickly as possible, when there is generated a necessity of sounding the emergency earthquake quick report.

### BRIEF DESCRIPTION OF THE SEVERAL VIEWS OF THE DRAWING

FIG. 1 is a block diagram for showing the structure of a digital broadcast receiver apparatus capable of receiving earthquake alarm information, according to a first embodiment of the present invention;

FIG. 2 is a block diagram for showing an embodiment of a digital broadcast transmitter apparatus for transmitting a digital broadcast, which is received by the digital broadcast receiver apparatus, according to the present invention;

FIG. 3 is an explanatory view for showing the structure of the earthquake alarm information, which is received by an earthquake alarm information receiver portion 120, being a principal block of the present invention;

FIG. 4 is an explanatory view for showing the structure of the earthquake alarm information, which is received by the earthquake alarm information receiver portion 120, being the principal block of the present invention;

FIG. 5 is an explanatory view for showing the structure of the earthquake alarm information, which is received by the earthquake alarm information receiver portion 120, being the principal block of the present invention;

FIG. 6 is an explanatory view for showing the structure of the earthquake alarm information, which is received by the earthquake alarm information receiver portion 120, being the principal block of the present invention;

FIG. 7 is an explanatory view for showing the structure of the earthquake alarm information, which is received by the earthquake alarm information receiver portion 120, being the principal block of the present invention;

FIG. 8 is an explanatory view for showing an operation of the earthquake alarm information, which is received by the earthquake alarm information receiver portion 120, being the principal block of the present invention;

FIG. 9 is an explanatory view for showing the structure of the earthquake alarm information, which is received by the earthquake alarm information receiver portion 120, being the principal block of the present invention;

FIG. 10 is an explanatory view for showing the structure of the earthquake alarm information, which is received by the earthquake alarm information receiver portion 120, being the principal block of the present invention;

FIG. 11 is an explanatory view for showing the structure of the earthquake alarm information, which is received by the earthquake alarm information receiver portion 120, being the principal block of the present invention;

FIG. 12 is an explanatory view for showing the structure of the earthquake alarm information, which is received by the earthquake alarm information receiver portion 120, being the principal block of the present invention;

FIG. 13 is an explanatory view for showing the structure of a TMCC signal, which is received by a TMCC decoder potion 113, being a principal block of the present invention;

FIG. 14 is an explanatory view for showing the structure of the TMCC signal, which is received by the TMCC decoder potion 113, being the principal block of the present invention;

FIG. 15 is an explanatory view for showing the structure of the TMCC signal, which is received by the TMCC decoder potion 113, being the principal block of the present invention;

FIG. 16 is an explanatory view for showing the structure of the TMCC signal, which is received by the TMCC decoder potion 113, being the principal block of the present invention;

FIG. 17 is an explanatory view for showing an example of a transmission management and a receiving operation of the TMCC signal, which is received by the TMCC decode potion 113, being the principal block of the present invention;

FIG. 18 is an explanatory view for showing an example of a transmission management and a receiving operation of the TMCC signal, which is received by the TMCC decoder potion 113 and the earthquake alarm information receiver portion 120, being the principal blocks of the present invention;

FIG. 19 is an explanatory view for showing an example of the transmission management and the receiving operation of the TMCC signal, which is received by the TMCC decoder potion 113 and the earthquake alarm information receiver portion 120, being the principal blocks of the present invention;

FIG. 20 is an explanatory view for showing an example of the transmission management and the receiving operation of the TMCC signal, which is received by the TMCC decoder potion 113 and the earthquake alarm information receiver portion 120, being the principal blocks of the present invention;

FIG. 21 is an explanatory view for showing an example of the transmission management and the receiving operation of the TMCC signal, which is received by the TMCC decoder potion 113 and the earthquake alarm information receiver portion 120, being the principal blocks of the present invention;

FIG. 22 is an explanatory view for showing an example of the transmission management and the receiving operation of the TMCC signal, which is received by the TMCC decoder potion 113 and the earthquake alarm information receiver portion 120, being the principal blocks of the present invention;

FIG. 23 is an explanatory view for showing an example of the transmission management and the receiving operation of the TMCC signal, which is received by the TMCC decoder potion 113 and the earthquake alarm information receiver portion 120, being the principal blocks of the present invention;

FIG. 24 is an explanatory view for showing an example of the transmission management and the receiving operation of the TMCC signal, which is received by the TMCC decoder potion 113 and the earthquake alarm information receiver portion 120, being the principal blocks of the present invention;

FIG. 25 is a block diagram for showing an example of a discrimination portion 117, i.e., a principal blocks of the present invention;

FIG. 26 is a block diagram for showing the structure of a digital broadcast receiver apparatus capable of receiving earthquake alarm information, according to a second embodiment of the present invention;

FIG. 27 is a block diagram for showing embodiments of a decoder portion 108, and composition portions 2601 and 2602, being principle blocks of the second embodiment of the present invention;

FIG. 28 is a block diagram for showing embodiments of the decoder portion 108, and the composition portions 2601 and 2602, being principle blocks of a third embodiment of the present invention;

FIG. 29 is a block diagram for showing the structure of a digital broadcast receiver apparatus capable of receiving earthquake alarm information, according to a fourth embodiment of the present invention;

FIG. 30 is a block diagram for showing embodiments of the discriminator portion 117, and an output portion 2901, being principle blocks of the fourth embodiment of the present invention;

FIG. 31 is an explanatory view of the digital broadcast, which is transmitted by the digital broadcast transmitter apparatus according to the present invention; and

FIG. 32 is an explanatory view of the digital broadcast, which is transmitted by the digital broadcast transmitter apparatus according to the present invention.

### EMBODIMENT(S) FOR CARRYING OUT THE INVENTION

Hereinafter, embodiments according to the present invention will be fully explained by referring to the attached drawings. However, in the drawings, the same reference numeral presents the same or corresponding portion thereof. Also, the present invention should not be limited only to the embodiments illustrated in the figures.

### Embodiment 1

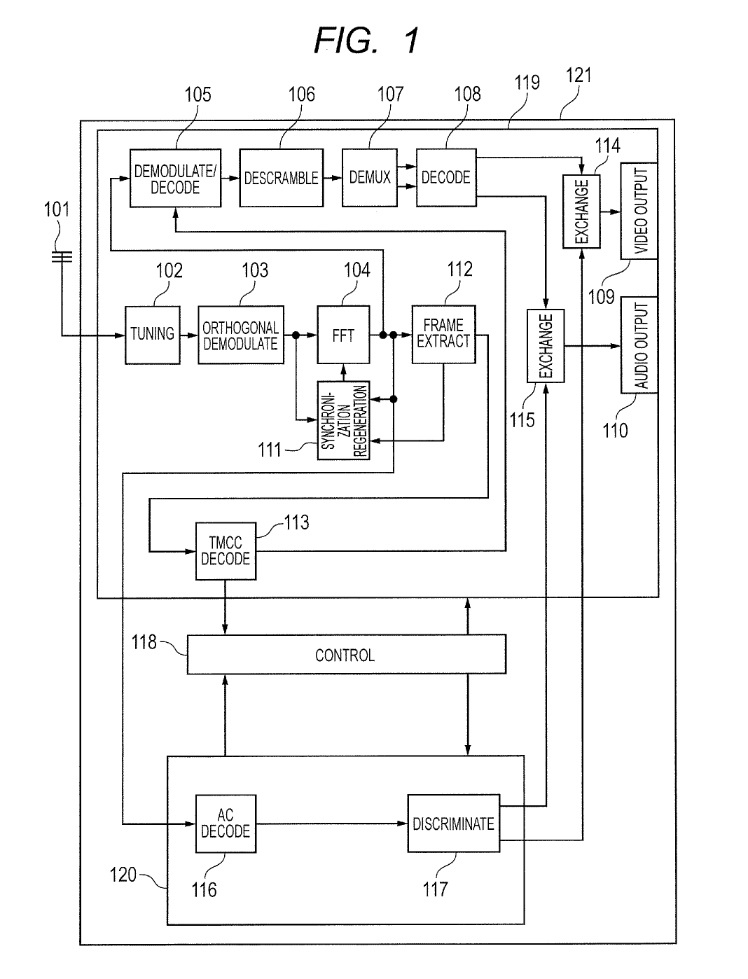

FIG. 1 is a block diagram for showing the structure of a digital broadcast receiver apparatus for receiving earthquake alarm information, which is transmitted with applying an AC signal included in a segment number “#1”, in the embodiment 1 according to the present invention.

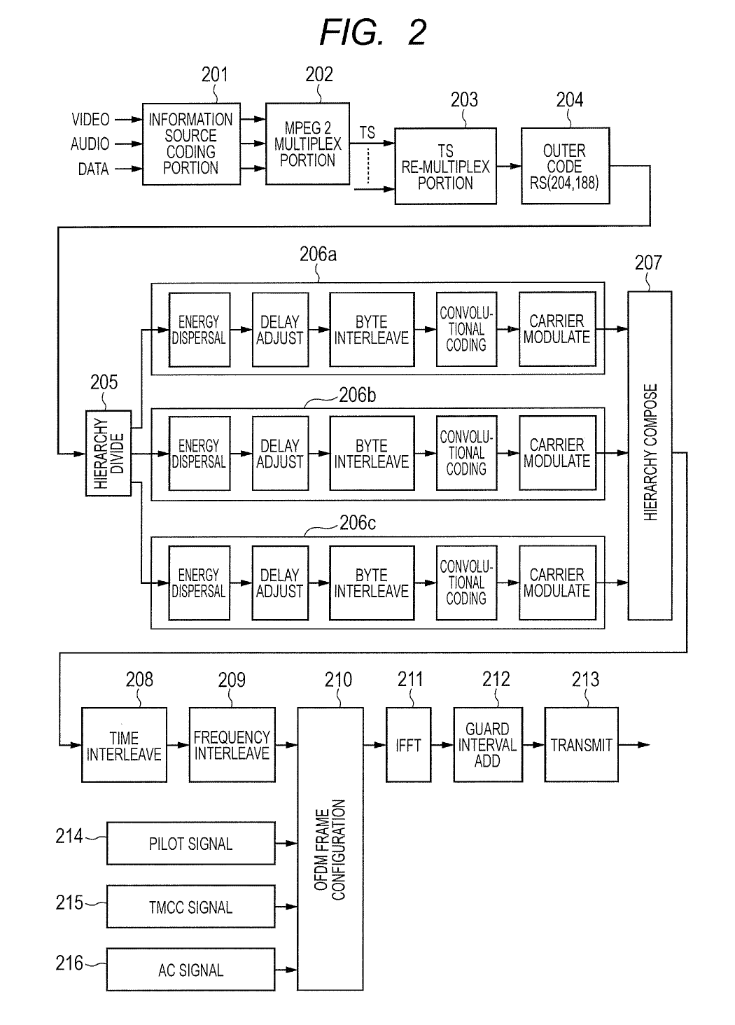

Also, in FIG. 2 is shown a block diagram of an embodiment of a digital broadcast transmitter apparatus for transmitting a digital broadcast, which is received by the digital broadcast receiver apparatus, according to the present invention.

In accordance with the present digital broadcast method, plural numbers of MPEG-2 transport streams (MPEG-2 transport stream, hereinafter, being described “TS”), after being combined into one (1) piece of through re-multiplication and being treated with a transport path coding process thereon, are converted, in the block thereof, into OFDM (Orthogonal Frequency Division Multiplexing) transmission signals, being composed of plural numbers of subcarriers through IFFT (Inverse Fast Fourier Transform); thereby to be transmitted as a broadcast wave.

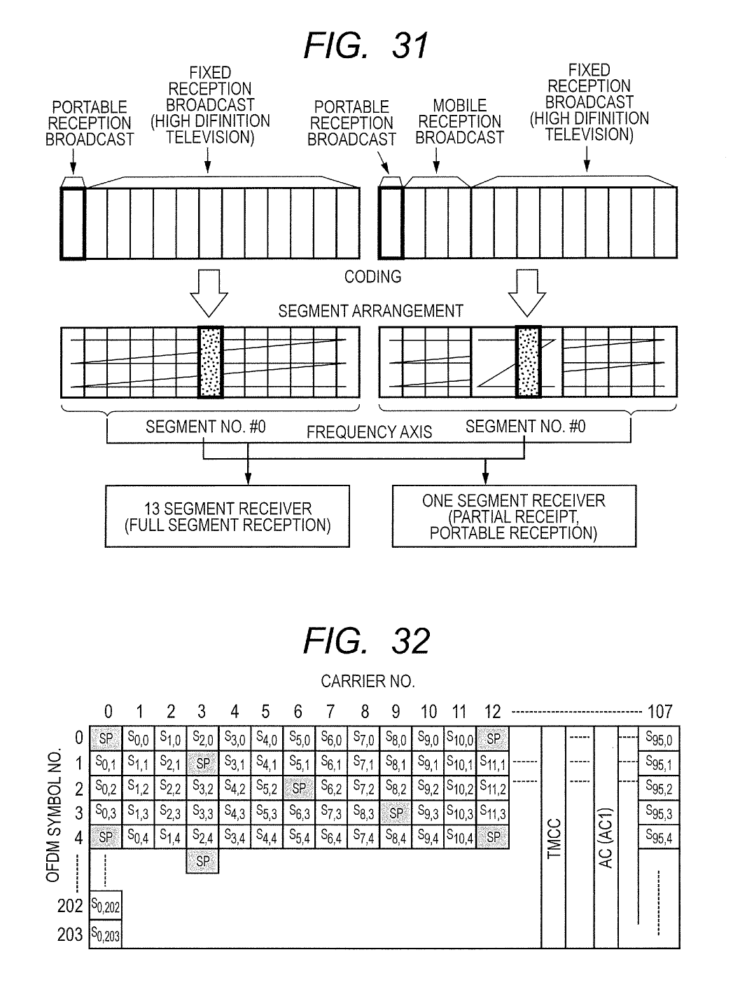

Herein, the OFDM transmission signal has such a structure that thirteen (13) pieces of OFDM segments, equally dividing a transmission band width 6 MHz into fourteen (14) pieces, are connected, and with this it is possible to transmit a hierarchy (s), up to three (3) hierarchies at the maximum, with a unit of OFDM segment. Also, among thirteen (13) pieces of segments of the OFDM transmission signal, a segment at the center thereof (i.e., the segment number “#0”) can be determined as a partial reception hierarchy upon an assumption of reception by a mobile receiver, such as, a portable telephone, etc. FIG. 31 shows the segment structure thereof. However, a receiver, which can receive all of the thirteen (13) segments of the OFDM transmission signal, is called, “13 segment receiver”, and a receiver, which can receive the one (1) segment at the center of the OFDM transmission signal, is called, “one segment receiver”, respectively.

In the present digital broadcast method is applied such a frame structure that a TMCC (Transmission and Multiplexing Configuration Control) signal for transmitting control information to conduct a decoding operation of the receiver, such as, a system discrimination, a transmission parameter exchange index, an emergency alarm broadcast activation flag, a transmission parameter for each of the hierarchies, etc., and also an AC (Auxiliary Channel) signal, i.e., an extension signal for transmitting additional information relating to transmission control of a carrier wave, are added to, in the frame structure thereof. This frame structure is shown in FIG. 32. In this FIG. 32, carrier positions and a number of pieces of the TMCC signals and also the AC signals, which are to be added as OFDM subcarriers, are different from depending on transmission parameters. The details thereof will be mentioned later.

Herein, the emergency alarm broadcast (EWS: Emergency Warning System), which is initialized by the emergency alarm broadcast activation flag transmitted on TMCC is that to be used for noticing the emergency information to a viewer/listener, as quickly as possible, when a tsunami (a tidal wave) alarm due to generation of the earthquake is issued. In case of managing the emergency alarm broadcast, a broadcast station turns the emergency alarm broadcast activation flag, which is included in the TMCC signal, into “ON”; i.e., executing the broadcast with such a content, that it can be recognized to be the emergency alarm broadcast.

As a system for transmitting for transmitting further developed emergency, there is an Earthquake Early Warning (EEW). This Earthquake Early Warning is such information that it can be obtained by analyzing preliminary tremors (i.e., a P wave) and a principal shock (i.e., aSwave), which are caught by seismometers near to a focus of the earthquake, to estimate the focus of the earthquake and/or a magnitude of the earthquake, immediately, just after an occurrence of the earthquake, and upon basis of this, thereby presuming and noticing the magnitudes at various places, as quickly as possible. Also, the EEW is made for the purpose of noticing the viewers/listeners before a strong quake arrives, to let them to ensure safeties for themselves, not in confusion, depending on peripheral conditions of them. This EEW is transmitted with using the AC signal, which is contained in the segment number “#0”.

However, although such the name, as Earthquake Early Warning (EEW) is used, in general, but a name, “earthquake alarm information”, is used, according to a notice of a ministerial ordinance, and hereinafter is used the “earthquake alarm information”.

The earthquake alarm information is the information relating to an earthquake alarm, which is executed in accordance with a provision of Article 13 (1) of a weather service law (i.e., a law 165 of showa 27 (1952)).

Explanation will be given on an operation of the digital transmitter apparatus for achieving the present digital broadcast method.

A reference numeral 201 depicts an information source coding portion, 202 a MPEG 2 multiplexer portion, 203 a TS re-multiplexer portion, 204 a RS (Reed-Solomon) coding portion, and 205 a hierarchy divider portion, respectively. A reference numeral 206 depicts a parallel processor portion, and three (3) systems thereof are provided; e.g., “a”, “b” and “c”. A reference numeral 207 depicts a hierarchy composition portion, 208 a time interleave portion, 209 a frequency interleave portion, 210 an OFDM frame structure portion, 211 an inverse Fourier transformation (hereinafter, “IFFT”) portion, 212 a guard interval adder portion, 213 a transmitter portion, 214 a pilot signal composition portion, 215 a TMCC signal composition portion, and 216 an AC signal composition portion, respectively.

According to the present digital broadcast method, after one (1) or plural numbers of transports (TS), being defined by MPEG 2 Systems, are combined into one (1) piece of TS through the re-multiplexing, and is/are treated with plural numbers of transmission coding thereon depending on intensions of services, they are transmitted, finally, as one (1) piece of an OFDM signal. A transmission spectrum of television broadcast is constructed by connecting thirteen (13) pieces of OFDM blocks (hereinafter, being called “OFDM segments”), which are obtained by dividing a channel bandwidth of the television broadcast into fourteen (14) pieces, equally. With structuring the carrier configuration of the OFDM segments in such a manner that the plural numbers of segments can be connected with, it is possible to achieve a transmission band width suitable to a medium, by a unit of the segment width. Since the transmission path coding is executed in a unit of the OFDM segment, a portion thereof can be assigned to a fixed receiving service while others to a mobile receiving service, within one (1) television channel. Such transmission as mentioned above is defined as a hierarchy transmission. Each hierarchy is made up with one (1) or plural numbers of OFDM segment(s), and for each hierarchy can be determined a parameter, such as, a carrier modulation method, a coding rate of inner codes and a time interleave length, etc. However, a possible number of levels of the hierarchies is three (3) at the maximum, and a partial receiving is also counted as one (1) hierarchy. A number the segments and a transmission path coding parameter(s) for each hierarchy are determined, in accordance with composition information, and are transmitted by the TMCC signal, as control information for assisting the operation of a receiver. With the OFDM segment at a central portion of the television broadcast signal, which is constructed by thirteen (13) segments, it is possible to execute the transmission path coding of conducting a frequency interleave only within that segment. With this, it is possible to receive apart of the television service, partially.

By taking adaptability to distance between provided stations of SFN, or durability to a Doppler shift in a reception during movement into the consideration thereof, the present digital broadcast method comprises three (3) different distances of the OFDM carriers. Those can be recognized as a mode of the system. The carrier distance is about 4 kHz in a mode 1, about 2 kHz in a mode 2, and about 1 kHz in a mode 3, respectively. The number of carries differs from, depending on the mode; however a transmittable information bit rate is always the same for any one of the modes.

In the information source coding portion 201, a video signal, an audio signal and data are coded, respectively, and in the MPEG 2 multiplexer portion 202, one (1) piece of TS is produced. Plural numbers of TS, which are outputted from the plural numbers of MPEG 2 multiplexer portions, are inputted into the TS re-multiplexer portion 203, to be in disposition being suitable for signal processing in a unit of data segment. In the TS re-multiplexer portion 203, they are converted into a burst signal form of a unit of 188 bytes by a clock, being as 4-times higher as an IFF sampling clock, and in the RS coding portion 204, are converted into a single TS, as well as, being added a Reed-Solomon outer code thereto. Thereafter, in particular, in case of conducing the hierarchy transmission, they are divided in the hierarchy thereof along with a designation of hierarchy information within the hierarchy divider portion 205, and are inputted into the parallel processor portions 206a, 206b and 206c of the three (3) systems at the maximum. In the parallel processor portions 206a, 206b and 206c are treated, mainly, an error correction coding, a digital data processing, such as, an interleaving, etc., and a carrier modulation, respectively. Also, delay compensation is conducted for a delay time difference between the hierarchies, which are caused due to time-axis operations of a byte interleaving and a bit interleaving, in advance, so as to obtain a timing adjustment. The error correction, the interleave length, the carrier modulation method are determined, for each hierarchy, independently. After the parallel processing in the parallel processor portions 206a, 206b and 206c, the signals, which are composed in the hierarchies thereof in the hierarchy composition portion 207, are inputted into the time interleave portion 208 and the frequency interleave portion 209, to show an ability of the error correction coding, effectively, against change of an electric field and/or multi-path obstruction. As the method of the time interleave is adopted a folding interleave, for shortening the delay time, including those in transmission and in reception, and for suppressing a memory capacity of the receiver. Also, the frequency interleave potion is constructed by combining the interleaves between the segments and within the segment, so that it can shows an interleave effect, fully, while maintain the segment structure.

To the hierarchy transmission, in which plural numbers of transmission parameters coexist, for assisting demodulation/decoding of the receiver, the TMCC (Transmission and Multiplexing Configuration Control) signal is transmitted, with using a specific carrier. Also, for transmitting additional information relating to the broadcast, the AC (Auxiliary Channel) signal is applied therein.

In the OFDM frame structure portion 210, an OFDM frame is constructed with the information data from the frequency interleave portion 209, a pilot signal for use of reproduction of synchronization from the pilot signal composition portion 214, the TMCC signal from the TMCC signal composition portion 215, and the AC signal from the AC signal composition portion 216. This frame construction is shown in FIG. 32. “Si, j” presents a carrier symbol within the data segment after the interleave. “SP (Scattered Pilot)” is a reference pilot symbol for the receiver to conduct a quasi-synchronism detection or modulation. As is shown in FIG. 32, this is inserted by one (1) time for 12 carriers in the carrier direction, and by one (1) time for 4 symbols in the symbol direction. If interpolating the SP in the symbol direction on the side of reception, the SP of 3(12/4) carrier distance can be obtained. Since the maximum value of the guard interval length is ¼ of an effective symbol length, it is able to deal with the multi-paths up to the maximum delay time, with which no interference is generated between the symbols, due to the interpolation process (transmission path character presumption) by the SP at a distance of 3 carriers. However, in case where a guard interval ratio is ¼, theoretically, the SP at the distance of 4 carriers is enough; however, by taking the characteristics of an interpolation filter, etc., into the consideration thereof, the SP is inserted by one (1) time for 4 symbols in the symbol direction.

FIG. 32 shows an example of the mode 1, wherein the carrier numbers are from “0” to “107”, however comparing to those, they are from “0” to “215” and “0” to “431” in the mode 2 and the mode 3, respectively.

The AC signal is aligned as is shown in FIG. 32, and it has a data volume of 204 bits per 1 carrier. Also, two (2) pieces, four (4) pieces, or eight (8) pieces of the AC signals are aligned in each segment, in the mode 1, the mode 2 or the mode 3, respectively.

The TMCC signal is aligned as is shown in FIG. 32, and it has a data volume of 204 bits per 1 carrier. Also, one (1) piece, two (2) pieces, or four (4) pieces of the AC signals are aligned in each segment, in the mode 1, the mode 2 or the mode 3, respectively.

All of the signals, completing the frame configuration thereof, are converted into an OFDM signal through an IFFT calculation within the IFFT portion 211, and are also converted into an OFDM broadcast signal by adding a guard interval thereto, within the guard interval adder portion 212, and further converted into a digital broadcast signal of a predetermined frequency within the transmitter portion 213.

Next, explanation will be made on the operation of the digital broadcast receiver apparatus for receiving a transmission signal, which is transmitted by the digital broadcast transmitter apparatus shown in FIG. 2, by referring to FIG. 1.

A reference numeral 101 depicts an antenna, 102 a tuner portion, 103 an orthogonal modulator portion, 104 a high-speed Fourier transformation (hereinafter, being abbreviated by “FFT”) portion, 105 a demodulator/decoder portion for conducting demodulation/decoding according to the present digital broadcast method, after the FFT portion 104 up to an output of TS, 106 descramble portion, 107 a demux portion, 108 a decoder portion for a compressed broadcast video signal and a compressed broadcast audio signal, 114 and 115 exchanger portions, 109 a video output portion for conducting display of the broadcast video signal, which is decoded through the exchanger portion 114, and 110 an audio output portion for conducting outputting of the broadcast audio signal, which is decoded through the exchanger portion 115, respectively, wherein those builds up a main block for reproducing the broadcast video signal and the broadcast audio signal. Also, a reference numeral 111 depicts a synchronization regeneration potion, 112 a frame extractor portion, and 113 a TMCC decoder portion, respectively, wherein those execute the reproduction of a synchronization signal for the demodulator/decoder portion 105 to operate and obtain the information, such as, a transmission parameter, etc. Those elements from the tuner portion 102 to the TMCC decoder portion 113 and the exchanger portions 114 and 115 buildup the broadcast receiver portion 119.

On the other hand, a reference numeral 116 depicts an AC decoder portion, and 117 a discriminate portion, respectively, and those buildup an earthquake alarm information receiver portion 120.

The exchanger portions 114 and 115 execute exchanging between the video signal and the audio signal, to the decoder portion 108 and the discriminate portion 117, respectively.

A reference numeral 118 depicts a controller portion, for executing an operation control and an electric power control of the broadcast receiver portion 119 and the earthquake alarm information receiver portion 120.

A digital broadcast receiver apparatus 121 is build up with the controller portion 118, the broadcast receiver portion 119 and the earthquake alarm information receiver portion 120.

Hereinafter, detailed explanation will be give on the operation. A channel frequency band to be received is extracted within the tuner portion 102, thereby designate a UHF television broadcast channel, and orthogonal demodulation is executed on the signal, on which channel tuning is made, within the orthogonal modulator portion 103, to change it into a baseband signal, and then it is converted into a frequency-axis process within the FFT portion 104, wherein FFT is executed during the period corresponding to an effective symbol among OFDM symbols. In that instance, the condition of the multi-path of the reception signal is taken into the consideration, so that the FFT process is executed during an appropriate period. Upon reception of this, within the demodulator/decoder portion 105 is executed a demodulation process upon each carrier on the frequency-axis (for example, a synchronism demodulation is executed with applying a scattered pilot (SP: see FIG. 32), for QPSK, 16QAM, and 64QAM, thereby to detect an amplitude and phase information), and de-interleave and de-mapping of the frequency-axis and the time-axis are executed, being divided into each hierarchy, and further is executed the error correction, such as, a Viterbi decoding and/or RS (Reed-Solomon) decoding, etc., so that the digital broadcast signal is demodulated, and a transport stream (hereinafter, being abbreviated by “TS”), being defined in MPEG 2 systems, for example, is outputted to the descramble portion 106. Within the descramble portion 106, the TS signal, which is scrambled for the purpose of protection of the copywriting, is descrambled, and it is outputted to the demux portion 107. Within the demux portion 107 are extracted digital signals of the compressed broadcast video signal and the compressed broadcast audio signal, which are requested, to be outputted to the decoder portion 108. Within the decoder portion 108, the compressed broadcast video signal and the compressed broadcast audio signal are decoded, and the decoded broadcast video signal is outputted to the video output portion 109 through the exchanger portion 114, while the decoded broadcast audio signal to the audio output portion 110 through the exchanger portion 115, respectively.

On the other hand, in the synchronization regeneration potion 111, upon reception of the baseband signal from the orthogonal modulator portion 103, an OFDM symbol synchronization signal and a FFT sampling frequency are reproduced, depending on a mode and/or a guard interval length. In case where the mode and/or the guard interval length are unknown, determination can be made from a viewpoint of correlation of the guard period of the OFDM signal, etc. Further, a frequency position of the TMCC signal is detected from an output signal of the FFT portion 104. Within the frame extractor portion 112, the TMCC signal at the frequency position detected is demodulated, and also a frame synchronization signal is extracted from the TMCC signal. The frame synchronization signal is outputted to the synchronization regeneration potion 111, to be adjusted to the symbol synchronization signal in the phase thereof. Within the TMCC decoder portion 113, the error correction of difference-set cyclic code is treated upon the TMCC signal demodulated, so that TMCC information is extracted, such as, the hierarchical structure, the transmission parameters, etc. This TMCC information is outputted to the demodulator/decoder portion 105, and are used as various kinds of control information for the demodulation/decoding process.

The earthquake alarm information receiver portion 120 is constructed with the AC decoder portion 116 and the discriminate portion 117. In the AC decoder portion 116, when structure discrimination indicates transmission of the earthquake alarm information (for example, “001”, “110”, which will be mentioned later), the earthquake alarm information is extracted. In case where the structure discrimination is other than that, no AC signal is decoded. The earthquake alarm information extracted is discriminated in the information thereof within the discriminate portion 117, and when the earthquake alarm should be issued, that information is converted into the video signal and/or the audio signal; i.e., the video signal is outputted to the video output portion 109 through the exchanger portion 114, while the audio signal to the audio output portion 110 through the exchanger portion 115, respectively.

The controller portion 118, inputting emergency alarm broadcast activation flag information from the TMCC decoder portion 113 and/or the earthquake alarm information from the earthquake alarm information receiver portion 120 therein, controls the exchange portions 114 and 115 when the earthquake alarm should be issued, so as to output the video signal of the earthquake alarm into the video output portion 109, while the audio signal of the earthquake alarm into the audio output portion 110, respectively.

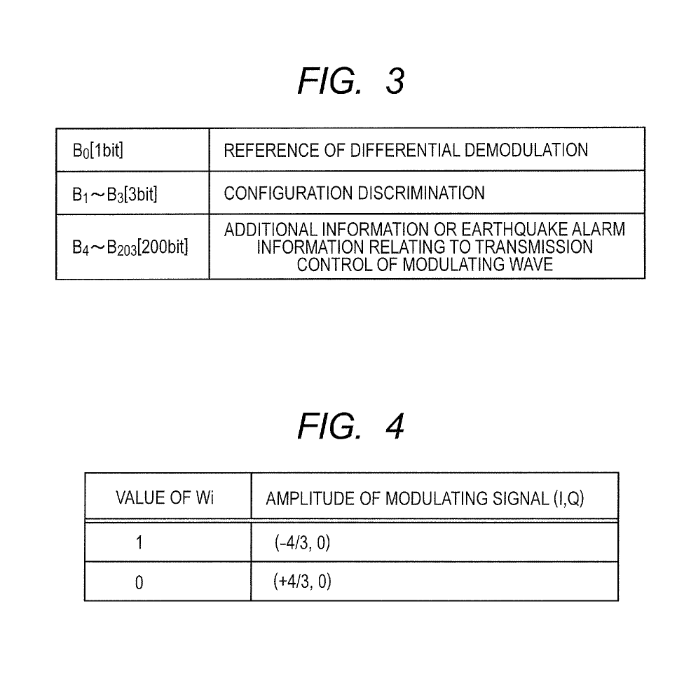

Next, explanation will be given on the configuration of the earthquake alarm information, which is composed within the AC signal composition portion 216 and is received by the earthquake alarm information receiver portion 120, by referring to FIGS. 3 to 12.

The AC signal means an additional information signal relating to the broadcast. The additional information signal relating to the broadcast means the additional information relating to the transmission control of a carrier wave, or the earthquake alarm information. The earthquake alarm information is transmitted with using an AC carrier of the segment “No. 0”. The AC signal is so aligned, as is shown FIG. 32, and has a data volume of 204 bits per 1 carrier.

FIG. 3 shows bit assignment of 204 bits (30-3203) of the AC signal, which is aligned in the segment “No. 0”.

An assumption is made that one (1) bit of B0 is a reference for a differential demodulation. Also, an assumption is made that three (3) bits, i.e., from B1 to B3 are the configuration discriminations, so as to distinguish to be the addition information or the earthquake alarm information. With two hundreds (200) bits from B4 to B203, the additional information or the earthquake alarm information is sent out. However, when sending out the earthquake alarm information, the same earthquake alarm information is sent out with using all of the AC carriers within the segment “No. 0”. With using all of the AC carriers within the segment “No. 0” for the same earthquake alarm information, the earthquake alarm information transmitted with using the AC carriers different from that can be added, in an analog manner, on the receiver side, and therefore it can be received at a CN ratio, being small much more.

FIG. 4 shows a reference of the differential demodulation of B0. With an assumption that the modulation method of the AC carrier is DBPSK, amplitude and a phase reference of the differential demodulation can be given “Wi” shown in FIG. 4.

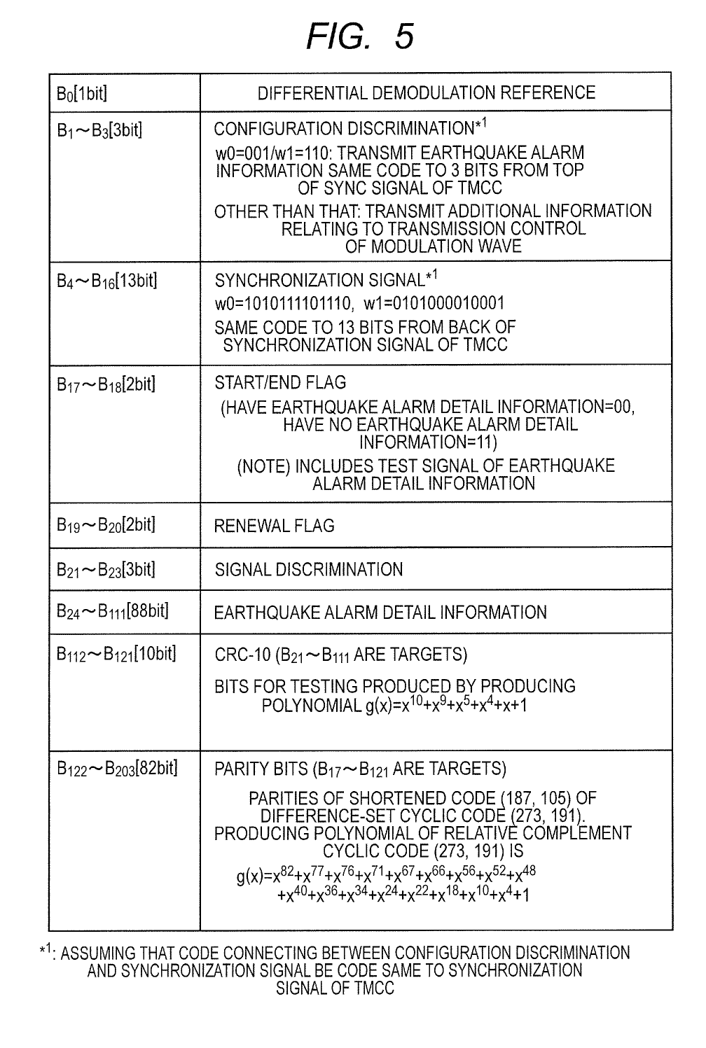

FIG. 5 shows a bit assignment when transmitting the earthquake alarm information, with using the AC signal of the segment “No. 0”.

If assuming the configuration discriminations are 000, 010, “011”, “100”, “101” and “111”, then AC is use for a licensed broadcast, as usual; i.e., the additional information relating to the transmission control of the carrier wave is transmitted.

If the configuration discriminations are “001” and “110”, then the earthquake alarm information is transmitted.

The “001” and “110” presenting the transmission of the earthquake alarm information are assumed to be codes, being same to top three (3) bits (B1-B3) of the synchronization signal of TMCC, and are transmitted, alternately, for each frame, at timing same to the TMCC signal.

The thirteen (13) bits of B4-B16 are assumed to the synchronization codes.

In case of the earthquake alarm information, the codes connecting the configuration discrimination and the synchronization signal are assumed to the codes being same to the synchronization codes of TMCC, i.e., being constructed with words of 16 bits. The synchronization signals are assumed to have two (2) kinds, i.e., w0=0011010111101110 and w1=1100101000010001 reversed in the bits thereof. Being assigned with bits, being same to those of the TMCC synchronization signal (B1-B16), “w0” and “w1” are transmitted, alternately, for each frame, at the same timing, thereby transmitting the codes same to that of TMCC. Since an analog calculation can be made with the TMCC signal and the AC signal, it is possible to improve or increase receiving sensitivity of frame synchronization in the receiver.

Two (2) bits of “B17”-“B18” are assumed to be a start/end flag of the earthquake alarm information.

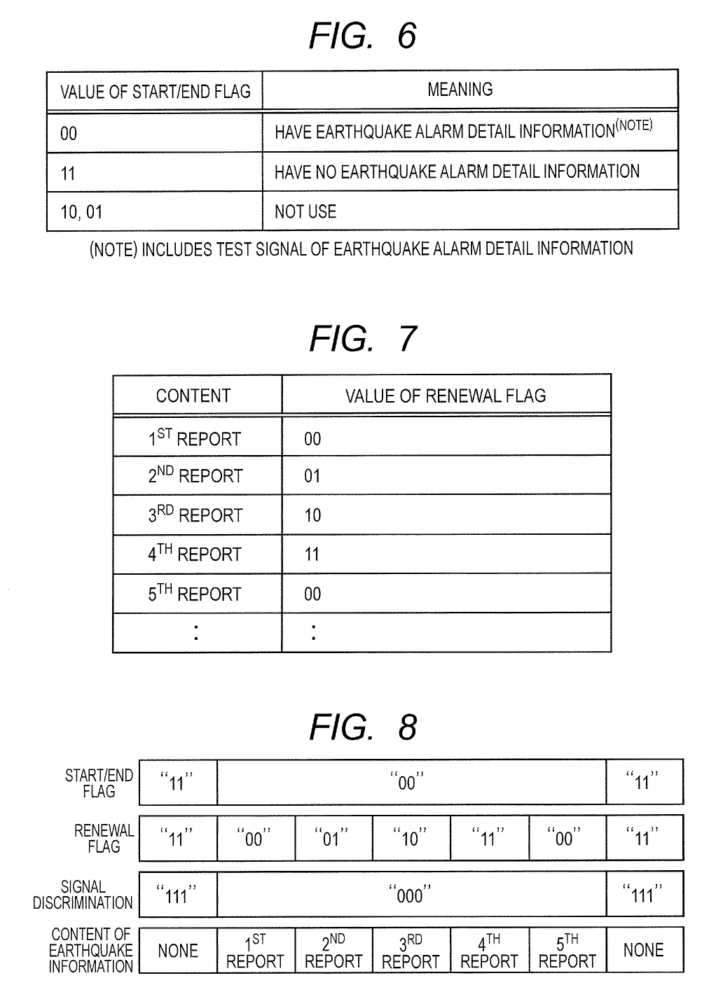

FIG. 6 shows meanings of the start/end flag of the earthquake alarm information.

For automatically starting the receiver where the earthquake alarm information is issued, and for indicating that the earthquake alarm information is transmitted with using the AC signal, two (2) bits are assigned to be the start/end flag of the earthquake alarm information.

Since all of the bits of the AC signal are modulated into “1”, when there is no information to be transmitted, the start/end flag is assumed to be “00”, when they present earthquake alarm detail information or a test signal thereof. Also, for the purpose of increasing reliability thereof are used two (2) bits, being reversed signals, for maintaining the distance between the codes at the maximum. Also, for maintaining the reliability of the start/end flags, “10” and “01” are not used therein.

When starting the transmission of the earthquake alarm information, the start/end flag is changed from “11” to “00”. Also, when ending the transmission of the earthquake alarm information, the start/end flag is changed from “00” to “11”. The start/end flag can be used also as a start signal of the receiver.

Two (2) bits of “B19”-“B20” are assumed to a renewal flag.

FIG. 7 shows meanings of earthquake alarm information renewal flag.

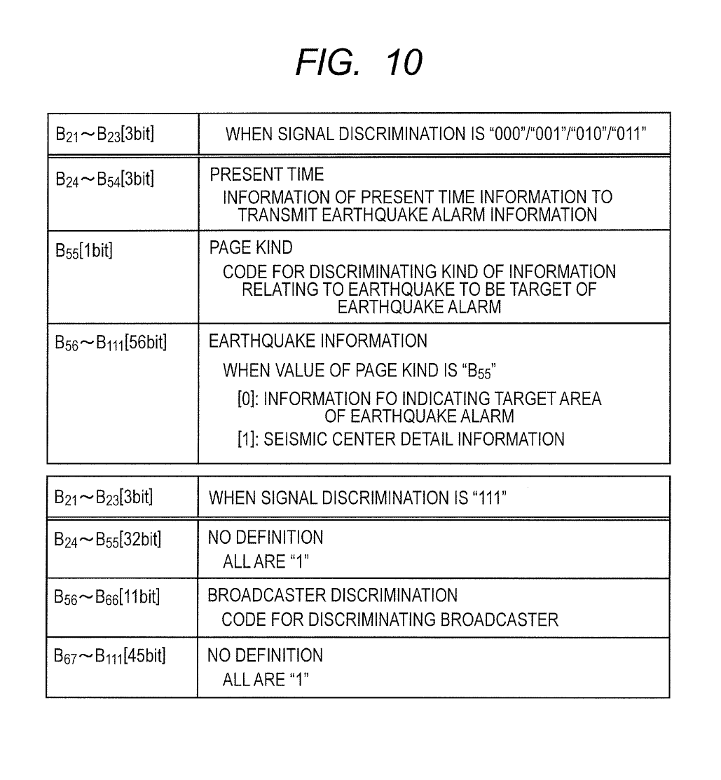

In case where renewal is made on the contents of the signal discrimination (B21-B23) or earthquake information (B56-B111) shown in FIG. 10 (which will be mentioned later), during when the values of the start/end flags of the earthquake alarm information continue the condition of “00”, as is shown in FIGS. 7 and 8, the values of the renewal flag are incremented by one “1”, respectively, so that it is noticed to the receiver that the signal discrimination or the earthquake information is renewed.

The renewal flag is assumed to increase by one (1) every time when change occurs in any content of series of earthquake alarm detail information wherein the start/end flag is “00”, and it has “00” as a starting value thereof, and then turns back to “00”, next after “11”. The renewal flag is assumed to be “11”, when the start/end flag is “11”.

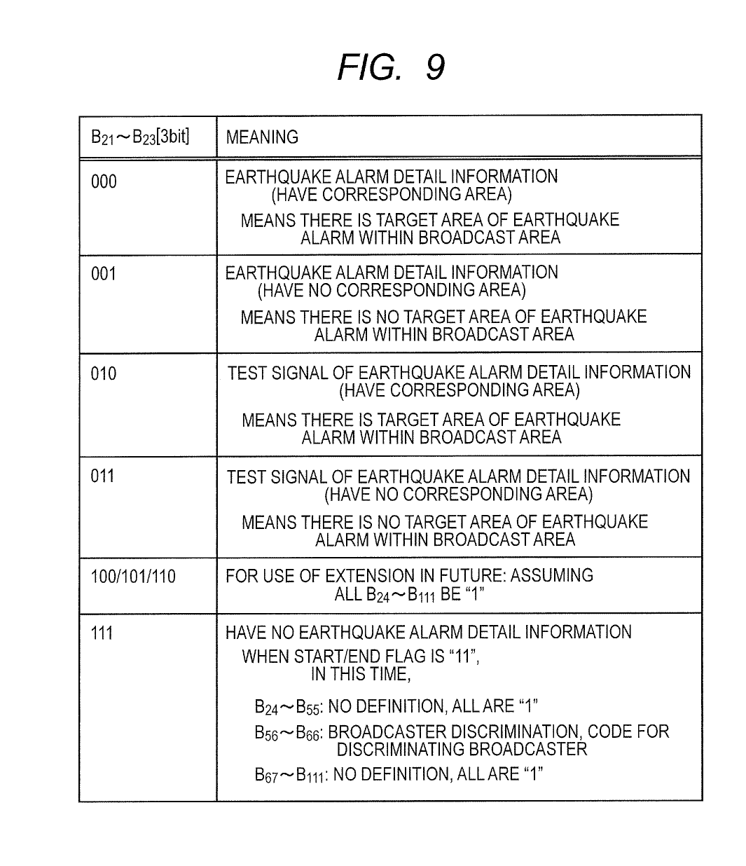

An example of emission of the renewal flag is shown in FIG. 8. A first report, a second report . . . show a condition that the signal discrimination shown in FIG. 9 (which will be mentioned later) or the content of the earthquake information shown in FIG. 10 (which will be mentioned later) is changing. Even if the present time or the page kind shown in FIG. 10 (which will be mentioned later) is changed, the value of the renewal flag does not change.

Three (3) bits of B21-B23 are assumed to be the signal discrimination.

FIG. 9 shows means of this signal discrimination.

The signal discrimination of the earthquake alarm information is a signal to be used for discriminating the kind of the earthquake alarm detail information. Where the start/end flag is “00”, the signal discrimination “000”/“001”/“010”/“011” is sent out, and where the start/end flag is “11”, the signal discrimination “111” is sent out. Also, the test signal of the earthquake alarm detail information (having/not having corresponding area) and the earthquake alarm detail information (having/not having corresponding area) are not sent out at the same time.

The signal discrimination “001”/“010”/“011” is for use of a future extension, and then all bits thereof are assumed to be “1”.

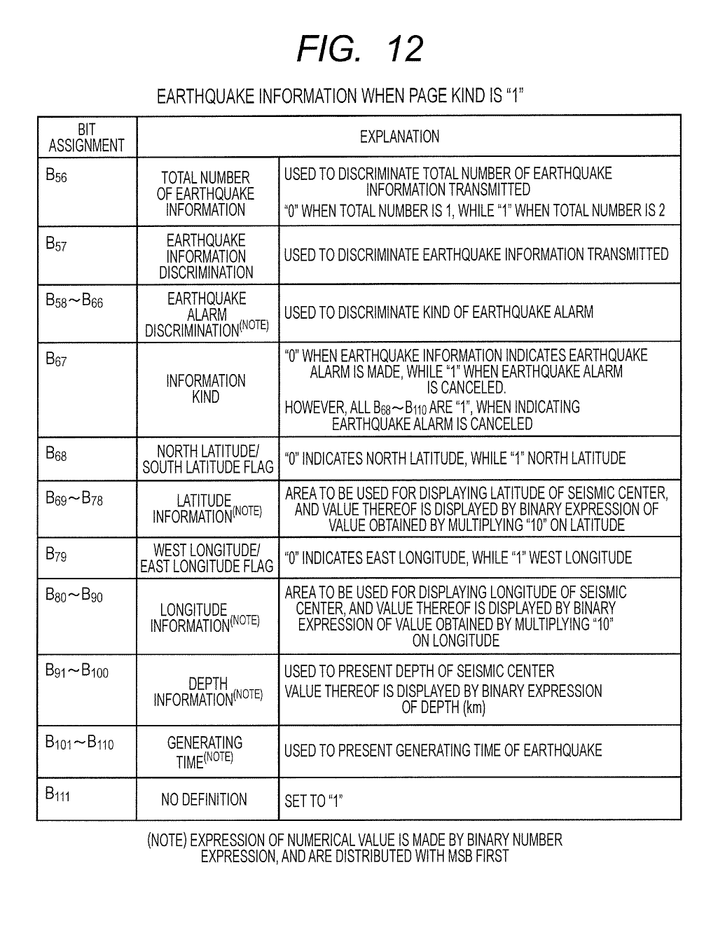

As shown in FIG. 12 (which will be mentioned later), although two (2) of the earthquake information can be sent out at the maximum in a total number thereof; however, it is assumed that the test signal and the main signal (i.e., the earthquake information) are not sent out at the same time. Also, in case where the signal discrimination sends out the earthquake information of having corresponding area and the earthquake information of not having corresponding area at the same time, any one of the information is sent out, as the earthquake information having corresponding area, so that it is possible to notice that at least one earthquake information is that having corresponding area, quickly, to the receiver.

Eighty-eight (88) bits of B24-B111 are assumed to be the earthquake alarm detail information.

FIG. 10 shows the details thereof. Assignments of bits of the earthquake alarm detail information are defined for each of the signal discriminations.

First of all, the earthquake alarm detail information when the signal discrimination is “000”/“001”/“010”/“011” are shown.

As “present time” is presented a number of seconds elapsing from a reference year/month/date/hour/minute/second by a binary number thereof, and lower thirty-one (31) bits thereof are assigned to in accordance with “MSB first”. When transmitting the earthquake alarm information, it is possible to confirm the reliability of the earthquake alarm information received, on an automatic-start enabled receiver, having a function of setting the time via TOT (Time Offset Table) or a communication network, etc., by referring to time of the receiver and time information sent out.

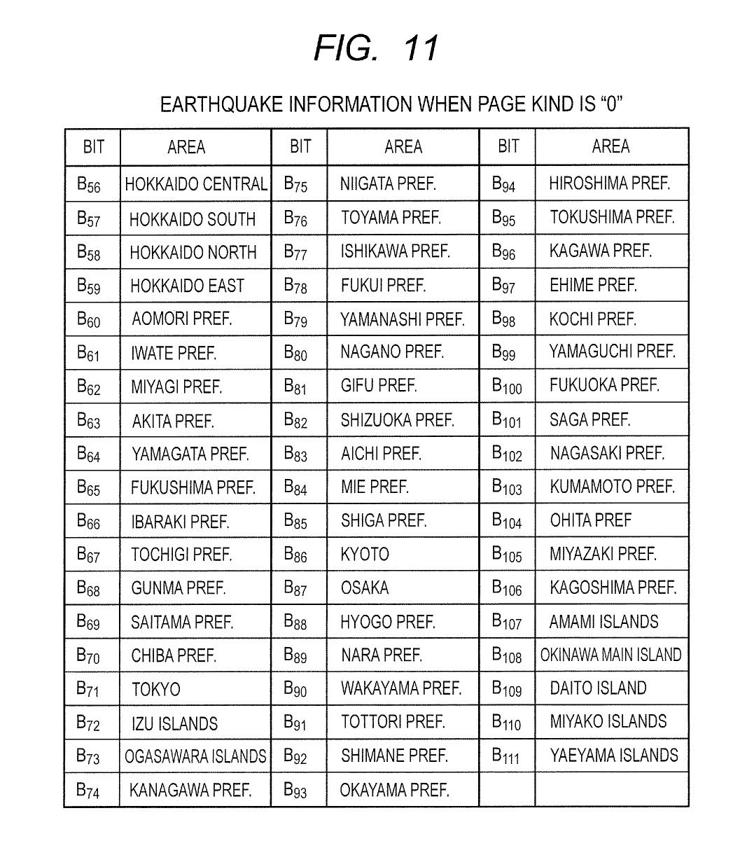

The earthquake information differs in assignment of information to be transmitted, depending on the code of the page kind. For the receiver, it is possible to know which information is transmitted, by confirming the page kind. In case where the page kind is “0”, as is shown in FIG. 11 (which will be mentioned later), information is transmitted, indicating a target area of the earthquake alarm. In case where the page kind is “1”, as is shown in FIG. 12, information is transmitted, relating to the focus of earthquake. However, it is not always true that both the earthquake information having the page kinds “0” and “1” are transmitted.

In case where not earthquake information is sent out, the page kind is turned to “0” while all of the earthquake information to “1”.

Next, the earthquake alarm detail information when the signal discrimination is “111” will be shown.

Broadcaster discrimination 11 bits are assigned to broadcasters of the whole country, uniquely. It is possible to discriminate the broadcaster by only means of the AC signal.

When the start/end flag is “11”, the signal discrimination “111” is sent out.

FIG. 11 shows the earthquake information when the page discrimination is “0”. When the page discrimination is “0”, it is assumed to be the information indicating the target area of the earthquake alarm, and FIG. 11 shows the assignment of the bits of the target area. It is assumed that the bit to be assigned to the area including the target area of the earthquake alarm therein, is “0”, while the bit to be assigned to the area, not including the target area of the earthquake alarm therein, is “1”.

In case where plural numbers of the earthquake alarms are generated at the same time (the total maximum is “2”), there are cases where, regarding the earthquake information (area information) of the page kind “0”, a first one and a second thereof are send out, respectively, and in this instance, the renewal flag is not renewed when the transmission of the earthquake information (area information) changes from the first one to the second one, or the second one to the first one.

FIG. 12 shows the earthquake information when the page kind is “1”.

To “earthquake alarm discrimination”, when plural numbers of the earthquake alarms are generated, nine (9) bits are assigned, for discriminating the earthquake alarm information. For distinguishing the plural numbers of the earthquake alarms, if determination is made upon basis of time (by a unit of second), the earthquake alarm discrimination of 9 bits enables to discriminate the earthquake alarm information among of those, which are generated during 8 minutes and 32 seconds in the past. Comparison between a present time of B24-B54 and a generation time of B101-B110 enables to know a number of seconds elapsing from generation of the earthquake.

The earthquake alarm discrimination of B57 is assumed to be “0” when the earthquake information transmitted is the first information, or be “1” when it is the second information.

As the generation time is presented a number of seconds elapsing from the reference time, by the binary number thereof, upon basis of year/month/date/hour/minute/second same to those shown by B24-B54, and lower ten (10) bits are assigned to in accordance with “MSB first”.

Ten (10) bits of B112-B121 are assumed to be CRC-10.

Since the information relating to the earthquake alarm detail information is important information and is required to be high in the reliability thereof, error detection can be made with CRC, after being decoded through an error correction code with using parity bits, which will be mentioned below.

To eighty-two (82) bits of B122-B203 are set parity bits, which are produced with using a shortened code (187, 105) of a difference-set cyclic code (273, 191), in the similar manner to an error correction code of TMCC.

Since the information relating to the earthquake alarm detail information is important information and is required to be high in the reliability thereof, it is protected by the error correction code with using the difference-set cyclic code, similar to TMCC. The configuration discrimination B1-B3 and the synchronization signal B4-B16 are assumed to be out of the targets of the error correction. The information of B17-B121 is coded with an error correction, with using the shortened code (187, 105) of the difference-set cyclic code (273, 191)®

A brief explanation will be given on a method for managing the earthquake alarm information, which was explained by referring to FIGS. 3 to 12 in the above, by referring to FIG. 5.

When the earthquake alarm information is transmitted on the AC carrier of the segment No. 0, the configuration discrimination is set to such values as shown in FIG. 5. When the earthquake occurs and the earthquake alarm is generated, the start/end flag is set to “have earthquake alarm detail information: “00””, and at the same time, the renewal flag, the signal discrimination, the earthquake alarm detail information and the parity bits are also set up. When the earthquake alarm is ended, the start/end flag is set to “have no earthquake alarm detail information: “11””.

Next, explanation will be made on the configuration of the TMCC signal, which is constructed within the TMCC signal composition portion 215, and is decoded within the TMCC decoder portion 113.

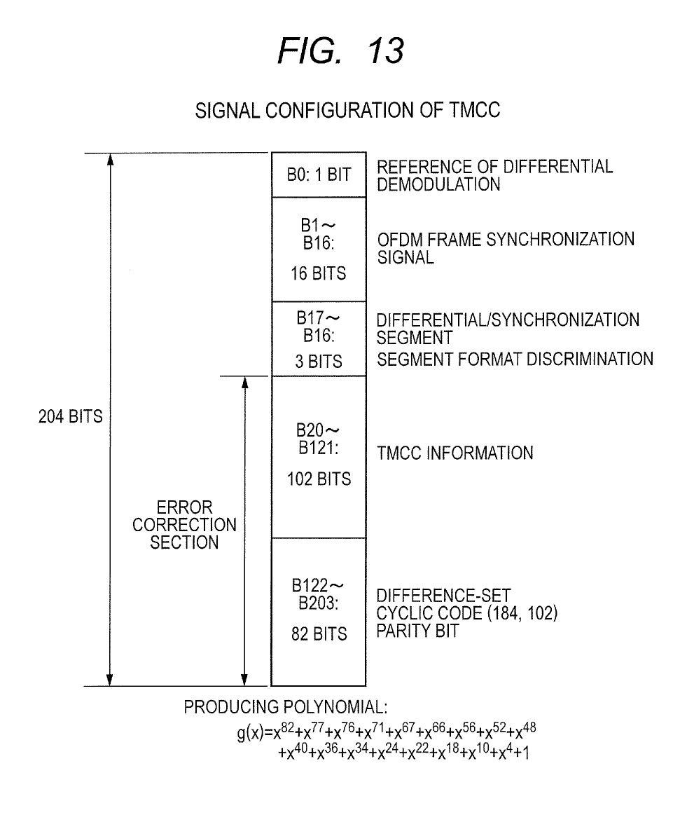

FIG. 13 shows the signal configuration of TMCC (bit assignments of TMCC carriers). The TMCC signal is for transferring the information relating to decoding operations of the receiver, such as, the hierarchical configuration and/or a transmission parameter of each OFDM segment, etc.

An amplitude and a phase reference of differential decoding are given by “W1” shown in FIG. 4.

The synchronization signal is constructed with a word of sixteen (16) bits. The synchronization signal has two (2) kinds; i.e., w0=0011010111101110 and w1=1100101000010001 reversed in the bits thereof, and w0 and w1 are transmitted, alternately, for each frame. The synchronization signal is used for the purpose of establishing synchronization of TMCC signal and frame synchronization of OFDM. For protecting from so-called a pseudo-synchronizing phenomenon, being produced when a bit pattern of TMCC information is coincident with the synchronization signal, the synchronization signal is reversed in the polarity thereof for each frame. Since the TMCC signal is never reversed for each frame, therefore the reversing for each frame enables the synchronization signal to escape from the pseudo-synchronizing.

Segment format discrimination is a signal for discriminating that segment, between the differential modulation portion or the synchronism modulation potion. This is constructed with a word of three (3) bits, i.e., “111” is assigned when it is the differential modulation portion, and while “000” is assigned when it is the synchronism modulation potion. The number of TMCC carriers differs from, depending on a format of segment, and comes to be one (1) piece in case where a partial receiving segment belongs to the synchronism modulation potion. For the purpose of enabling the decoding with certainty even in such case, three (3) bits are assigned to the discriminate signal, i.e., obtaining a reversed signal showing the maximum distance between codes.

The TMCC information is that for assisting the operations of demodulation and decoding in the receiver, such as, system discrimination, an index for exchanging transmission parameter, an emergency alarm broadcast activation flag, current information, next information, etc.

To a signal for the system discrimination are assigned two (2) bits. For a system of terrestrial digital television broadcast method is set up “00”, and for that of terrestrial digital broadcast audio method, being common in the transmission method, is set up “01”, respectively. The remaining values are for use of reserve.

The current information indicates the present hierarchical structure and transmission parameter(s), in the next information is shown the transmission parameter after being exchanged.

When exchange should be made on the transmission parameter, the index for exchanging transmission parameter is counted down, so that an exchange is informed to the receiver, so as to take or fix the timing. This index, normally, takes a value “1111”; however, when the transmission parameter is exchanged, it is subtracted by one “1” for each frame, from a position fifteen (15) frames before that the exchange be made. However, it is assumed to turn back to “1111” next to “0000”. The exchange timing is assumed to be a next frame synchronism for transmitting “0000”. Thus, a new transmission parameter is applied to the frames, in the order of those turning back to “1111”. The next information can be set or changed to an arbitrary timing, before the count-down starts for exchange; but cannot be altered during the counting-down thereof.

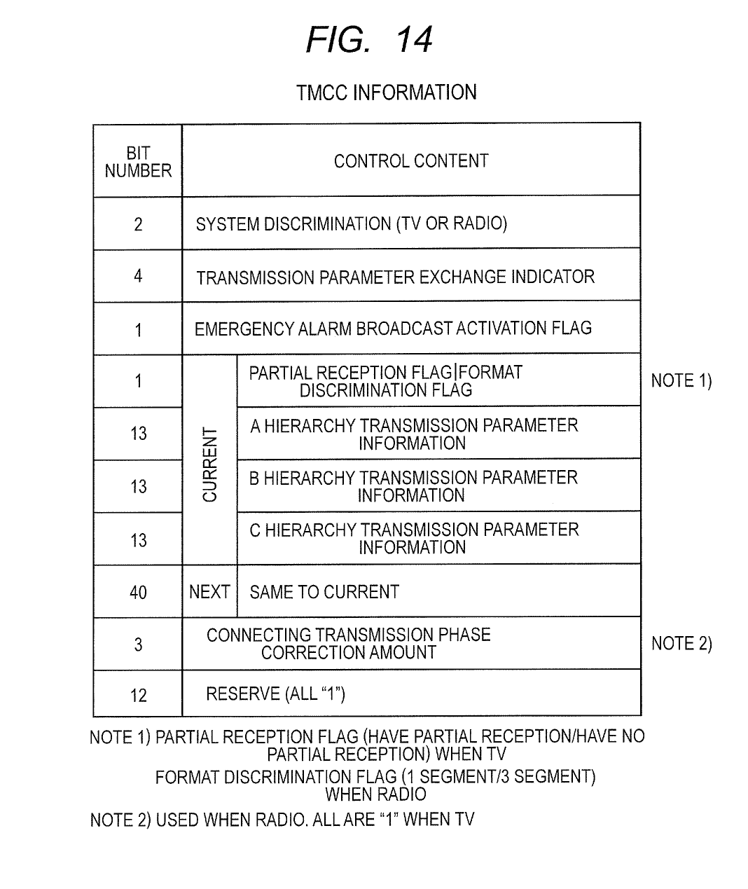

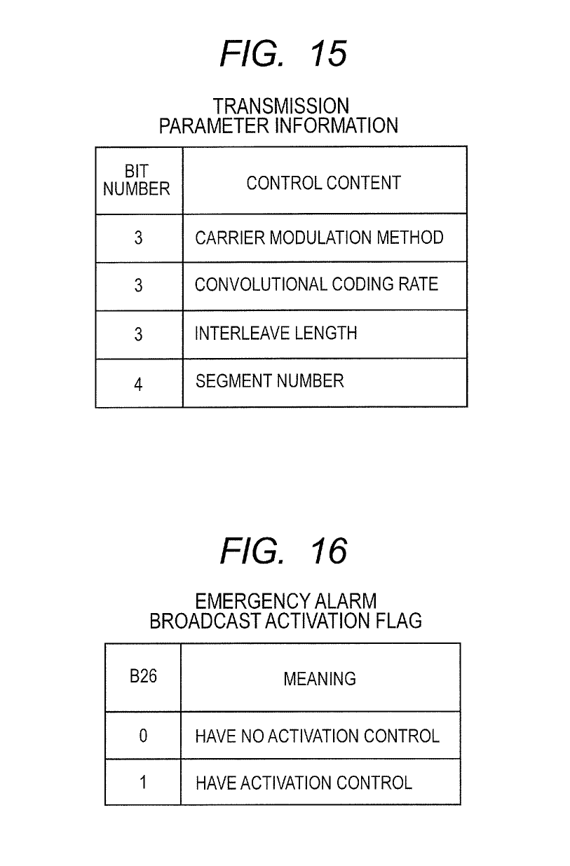

Bit assignments of TMCC information are shown in FIG. 14. Also, transmission parameter information included in the current/next information are shown in FIG. 15. If there is no unused hierarchy or next information within the transmission parameter information, the bits thereof are set to “1”.

When exchange should be made on any one (1) or more than that of the transmission parameters and the flags, which are included within the current information and the next information shown in FIG. 14 (i.e., the partial reception flag, the carrier modulation method, the convolutional coding rate, the interleave length, the segment number), the index for exchanging transmission parameter is counted down. When exchange should be made only on the emergency alarm broadcast activation flag, the index for exchanging transmission parameter is not counted down.

Assignment of the emergency alarm broadcast activation flag is shown in FIG. 16. On the emergency alarm broadcast, the activation flag is set to “1” when an activation control to the receiver is executed, while the activation flag to “0” when no activation control is done.

The partial reception flag is set to “1” when the segment at a center of the transmission band is set to that for use of the partial reception, while being set to “0” when it is not so. When the segment No. 0 is set to that for use of the partial reception, then that hierarchy is defined to be “A” hierarchy among those shown in FIG. 14. However, if there is no next information, then the flag is set to “1”.

A correction amount of coupling transmission phase is control information, which is used in the terrestrial digital audio broadcasts, being common with the transmission method thereof. Among 102 bits of the TMCC information, 90 bits are defined at present; however, the remaining 12 bits are reserved for use of extension in the future. Upon management, all of those reserve bits are stuffed with “1”.

The TMCC information B20-B121 is coded with an error correction coding with using the shortened code (184, 102) of the difference-set cyclic code (273, 191). The TMCC information needs high reliability of transmission than that for data signals, because it conducts an assignment of the transmission parameters and a control of the receiver. By taking the fact that sharing the decoding circuit for coupling codes in common within the receiver and also that block coding is advantageous from a viewpoint of processing delay into the consideration, the error correction code of TMCC is the shortened code (184, 102) of the difference-set cyclic code (273, 191). Also, because the TMCC signal is transmitted on plural numbers of carriers, it is possible to decrease C/N down to a desired value through analog addition of a signal, and thereby to improve a receiving capacity thereof. With the error correction technology and the adding processing, the TMCC signal can be received with C/N being smaller than that of the data signal. However, the synchronization signal and the information for discrimination of the segment format are taken out, from the target of the error correction, so that a majority rule can be made for each of the bits, including the parity bits therein, with treating all of the bits of the plural numbers of TMCC carriers equally.

Explanation will be made on a management of the emergency alarm broadcast (hereinafter, being abbreviated by “EWS”).

EWS follows the steps given below, when it starts and ends.

(When Starting)

(1) An emergency information descriptor, setting up the conditions of EWS (i.e., “start_end_flag”, first kind/second kind discrimination, and an area code) therein, is transmitted with PMT.

(2) The broadcaster sets the emergency alarm broadcast activation flag of TMCC to “1” and sends it out.

(3) The emergency alarm broadcast and the broadcast with recognizable contents are started.

(When Ending)

(1) The emergency alarm broadcast activation flag is tuned to “0” and is sent out.

(2) The emergency information descriptor is deleted from PTM.

(Treatment of the Emergency Alarm Broadcast Activation Flag of TMCC)

On a transmission side, in the service of conducting EWS, the emergency alarm broadcast activation flag of TMCC is set to “1”, always, during the period when the emergency alarm broadcast is conducted on any one of the services within TS (network), not depending on the transmission hierarchy. The receiver responding to the automatic activation observes the emergency alarm broadcast activation flag of TMCC, periodically.

(Position of Multiplying Emergency Information Descriptor)

The emergency information descriptor is described in a descriptor area 1 of PMT for the service of conducting that emergency alarm broadcast.

For the purpose of indicating an enforcement of the emergency alarm broadcast to the EWS enabled receiver, it is assumed that the corresponding descriptor is necessarily described in PMT of the emergency alarm broadcast service itself. Whether the emergency information descriptor should be described or not, in PMT of other services, depends on decision made by each broadcaster. However, when the service of different hierarchy is described, there is a possibility that it is neglected by the receiver.

(Change of Described Matters in Emergency Information Descriptor)

In case where there is generated a necessity of changing the content(s) (for example, the area code, etc.), which is/are described in the emergency information descriptor, during the enforcement of the emergency alarm broadcast, after conducting the steps for ending the EWS (i.e., turning the emergency alarm broadcast activation flag of TMCC into “0”, and deleting the emergency information descriptor from PMT), the changed emergency information descriptor is inserted into PTM, and thereafter, the emergency alarm broadcast activation flag of TMCC is turned into “1”, again. Or, alternately, after changing the described matters while disposing the emergency information descriptor on PMT with turning the emergency alarm broadcast activation flag of TMCC into “0”, the same flag can be turned into “1”. In any case, it is assumed that the period from the time when turning the emergency alarm broadcast activation flag into “0” up to the time when turning it into “1” takes one (1) second or more than that, and four (4) OFDM frames or more than that. Also, since the receiver continues the process of EWS for 90 seconds after the emergency alarm broadcast activation flag is turned into “0”, for the broadcaster, it is necessary to turn the emergency alarm broadcast activation flag into “1” within 90 seconds, when changing the target area, etc., but without ending the EWS.

(EWS Reception)

The fixed receiver must execute the following operations from (1) to (4).

(1) Observing the emergency information descriptor in the descriptor area locating at PMT of the received TS, after the emergency alarm broadcast activation flag of TMCC is changed from “0” to “1”.

(2) If “area_code” corresponds to the area code, which is is set within the receiver, at “start_end_flag=1” of the emergency information descriptor, receiving by tuning to the service described in the emergency information descriptor.

(3) Continuing the observation of period PMT, in which the emergency alarm broadcast activation flag of TMCC is “1”.

(4) Ending the emergency alarm broadcast at a time-point when the emergency alarm broadcast activation flag of TMCC is turned to “0” or at a time-point when the emergency information descriptor is deleted. However, there is a possibility that the emergency alarm broadcast started, again, depending on the management of “Change of Described Matters in Emergency Information Descriptor”, the receiver ends the operation after continuing the reception process of EWS at least for 90 seconds from the time when the emergency alarm broadcast is ended, and turns back to the condition before the activation thereof (last memory is not made on the service of EWS reception). Also, when the service is exchanged during the reception of EWS, the EWS reception process is ended; however, when the emergency alarm broadcast activation flag of TMCC is changed from “0” to “1”, the EWS reception process is started.
In case where “start_end_flag=0” of the emergency informing descriptor, no process is executed since it means the test broadcast.
In case of the receiver unable to receive TMCC when the power is OFF (i.e., a standby condition), it observes the emergency information descriptor in the descriptor area locating at PMT of the received TS, even if the emergency alarm broadcast activation flag of TMCC is “1” after the power source is turned ON, and starts the EWS reception process.
In case of the receiver able to receive TMCC when the power is OFF (i.e., the standby condition), it conducts the reception process of EWS mentioned above, even when the power is OFF (i.e., the standby condition).
In case where there is no corresponding PMT during the EWS reception process, it does not matter to end the reception process of the emergency alarm broadcast.

With a portable or mobile receiver, since there can be considered a case where the area code set up within the receiver differs from a actual location, the activation operation must be conducted, irrespective of “area code”, in the operation (2) of the fixed receiver mentioned above. However, in case where the reception area can be identified by any other means, it is outside of the rule mentioned above. Other than that, principally, it is assumed that the operation to that of the fixed receiver is conducted; however, it is also effective to make an alarming operation to the viewer/listener, i.e., making the portable or mobile receiver blinking or turning ON and OFF, etc., as an alternative means for the EWS reception process.

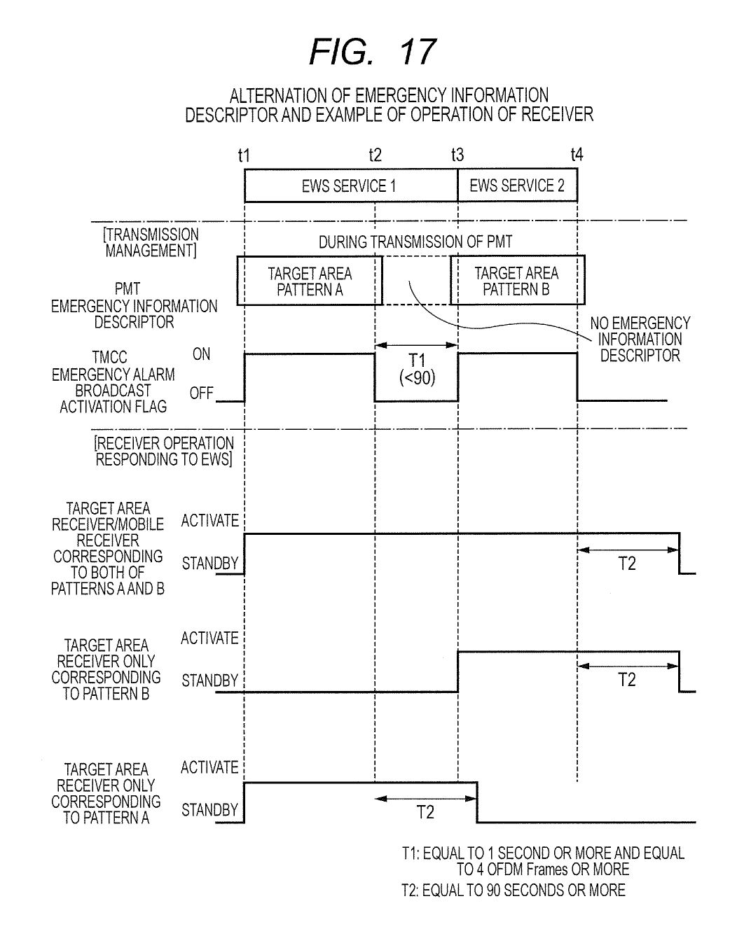

FIG. 17 shows therein the change of the emergency information descriptor mentioned above and operations of the receiver.

(Management of Emergency Alarm Broadcast Test Signal)

In the test broadcast of the emergency alarm broadcast, the management is made upon an assumption that a value of “start_end_flag” of the emergency information descriptor is turned to “0”, the side of end signal. During the period of the test broadcast, it is assumed that description of the corresponding descriptor into PMT is continued. Also, when the test broadcast is ended, the emergency information descriptor is deleted from the PMT fitting to timing when the emergency alarm broadcast activation flag of TMCC is turned to “0”.

Explanation will be given on the operation of receiving the earthquake alarm information, which was explained in FIGS. 3 to 12, by referring to FIG. 1.

In the AC decoder portion 116 shown in FIG. 1, the AC carriers within the segment No. 0 are extracted, to be decoded, and transmission of the earthquake alarm information is confirmed with using the configuration discrimination shown in FIG. 5, and further the synchronization is established. In this instance, since the transmission is conducted by the same earthquake alarm information on all of the AC carriers within the segment No. 0, analog addition of all the AC carriers within the segment No. 0 enables to demodulate the earthquake alarm information even under the condition of noise lowering. For example, if assuming that there are N pieces of the AC carriers, then the amplitude of the earthquake alarm information comes to N-times, but on the other hand, the noise does not come up to N-times since it has no correlation thereto on each AC carrier (i.e., mentioning this in the means of electric power, the noise comes up to only N-times comparing to N²-times of the earthquake alarm information).

Also, in the AC decoder portion 116, in case where it can be confirmed that the earthquake alarm information is sent to AC upon investigation of the configuration discrimination portion shown in FIG. 5, then as is explained by referring to FIG. 5, since the code connecting between the configuration description and the synchronization signal comes to be same to the synchronization signal of TMCC, analog addition of the code connecting between the configuration description and the synchronization signal and the synchronization signal of TMCC enables to reproduce the synchronization signal under the noise lowering, much better than reproducing it by only the TMCC, because of the reason mentioned above.

Further, also in the AC decoder portion 116, as a method for investigating the configuration discrimination portion shown in FIG. 5, it is possible to determine that the earthquake alarm information is set out to AC when the correlation can be found for all of the three (3) bits, while obtaining the correlation between portion of the synchronization signal of TMCC (.e., three (3) bits from the head thereof) and the configuration discrimination portion of the AC carrier within the segment No. 0, which is shown in FIG. 5.

When trying to receive the earthquake alarm information by the earthquake alarm information receiver portion 120, the tuner portion 102, the orthogonal modulation portion 103, the FFT portion 104, the synchronization regeneration potion 111, the frame extractor portion 112 and the AC decoder portion 116 are always operating. The operations of the tuner portion 102, the orthogonal modulation portion 103, the FFT portion 104, the synchronization regeneration potion 111 and the frame extractor portion 112 carry out the process only on the segment No. 0, i.e., so-called a one-segment portion, when receiving the earthquake alarm information. With doing this, it is possible to obtain an operation, being lower in the electric power consumption than that of processing all over 13 segments bands of the present digital broadcast.

Also, when trying to receive the earthquake alarm information by the earthquake alarm information receiver portion 120, the controller portion 118 is operating, always.

Within the AC decoder portion 116, the AC carriers within the segment No. 0 are extracted, to be decoded, and observation is made on the start/end flag of the earthquake alarm information shown in FIG. 5, judging from the meaning shown in FIG. 6, and further, on an initial stage, i.e., on the stage that no earthquake alarm information is issued, observation is made on a condition, exchanging from “have no earthquake alarm information” to “have earthquake alarm information”.

The discriminate portion 117 is in a stopping condition on the initial stage, i.e., on the stage where no earthquake alarm information is issued (i.e., the start/end flag of the earthquake alarm information “have no earthquake alarm information”).

Also, on the stage where no earthquake alarm information is issued, the demodulator/decoder portion 105, the descramble portion 106, the demux portion 107, the decoder portion 108, the exchanger portions 114 and 115, the video output portion 109 and the audio output portion 110 are in a stopping condition.

The TMCC decoder portion 113 is operating, always, when it tries to receive the emergency alarm broadcast, and observes the activation flag for the emergency alarm broadcast.

However, in this instance, the tuner portion 102, the orthogonal modulation portion 103, the FFT portion 104, the synchronization regeneration potion 111 and the frame extractor portion 112 are operating, always. As the operations of the tuner portion 102, the orthogonal modulation portion 103, the FFT portion 104, the synchronization regeneration potion 111 and the frame extractor portion 112, it is enough to carryout the process only on the segment No. 0, i.e., so-called the one-segment portion, when trying to receive the emergency alarm broadcast. With doing this, it is possible to obtain an operation, being lower in the electric power consumption than that of processing all over 13 segments bands of the present digital broadcast.

The operation when “have activation control” is as was explained by referring to FIGS. 13 to 17.

When the earthquake occurs and the earthquake alarm information is issued, in other words, when the start/end flag of the earthquake alarm information comes to “have earthquake alarm information”, detection is made on condition of exchanging from “have no earthquake alarm information” to “have earthquake alarm information” in the AC decoder portion 116, and “have earthquake alarm information”, i.e., the information that the earthquake alarm information is issued is transferred to the controller portion 118. The controller portion 118 transmits a control signal for brining the discriminate portion 117 into a normal condition while the broadcast receiver portion 119 into a standby condition. The AC decoder portion 116 outputs data to the discriminate portion 117, such as, the start/end flag of the earthquake alarm information shown in FIG. 5, which was extracted and determined at the time-point when the start/end flag of the earthquake alarm information comes to “have earthquake alarm information”, the earthquake alarm information renewal flag, the discriminate signal, the earthquake alarm information details, the CRC-10, the parity bits.

Within the discriminate portion 117 being under the normal condition, upon reception of the data from the AC decoder portion 116, an error correction is made of the shortened codes of the difference-set cyclic code, and after conducting the error correction of CRC-10, the signal discrimination shown in FIG. 5 is confirmed, so that it is determined which one of those meanings shown in FIG. 9 to have. And, depending on the respective meanings of those, processes determined in advance are conducted, and the discrimination information thereof is transmitted to the controller portion 118.

The controller portion 118, upon the discriminate signal from the discriminate portion 117, when the discriminate signal is “have earthquake alarm detail information (have corresponding area)”, shifts the broadcast receiver portion 119, being in the standby condition, from the standby condition to the normal condition, and controls the exchanger portion 114 and 115 to select the signal from the discriminate portion 117. The video signal and the audio signal for showing the earthquake alarm detail information from the discriminate portion 117 are outputted to the video output portion 109 and the audio output portion 110, respectively, so as to conduct the earthquake alarm.

However, although an example is shown, wherein the broadcast receiver portion 119 is controlled into the standby condition, in the above, but it is also possible to control only the exchanger portions 114 and 115, the video output portion 109 and the audio output portion 110 into the standby condition.

Further, although the example is shown, wherein the broadcast receiver portion 119 is controlled into the standby condition, in the above, but it is also possible to control only the exchanger portions 114 and 115, the video output portion 109 and the audio output portion 110 into the normal condition from the broadcast receiver portion 119 in the standby condition, or to control the exchanger portions 114 and 115, the video output portion 109 and the audio output portion 110 in the standby condition, into the normal condition. With doing those, there can be obtain an effect of enabling to conduct the earthquake alarm with consumption of an electric power, being lower than that of controlling the broadcast receiver portion 119.

Herein, the normal condition means a condition of operating normally, the standby condition means a condition of not operating but can be shifted into the normal condition, soon, and the stopping condition means a condition of not operating, respectively. The standby conditions of the broadcast receiver portion 119, the exchanger portions 114 and 115, the video output portion 109 and the audio output portion 110 means to turn electricity ON, so that the video output or the audio output can be made, quickly, when being it is shifted into the normal condition.

Explanation will be made on detailed operations of the discriminate portion 117.

The discriminate portion 117, confirming the signal discrimination shown in FIG. 5, so as to determine the meaning among of those shown in FIG. 9, and when the discriminate signal is “earthquake alarm detail information (have corresponding area)”, conducts alarming with using a buzzer sound or a voice, etc., or an alarm display with using blinking lights or displaying lights on a display. At the same time, the discriminate portion 117 conducts outputting of the audio signal and the video signal of the earthquake detail information, such as, information relating to an area including a prefecture, etc., where strong shock can be forecasted, and the seismic center information, and the time information, etc., as shown in FIGS. 10, 11 and 12, or conduct count-down until the time when the earthquake is forecasted to generate. At the same time, the controller portion 118 controls the broadcast receiver portion 119 being shifted into the standby condition, from the standby condition to the normal condition, and also controls the exchanger portions 114 and 115 to select the signal from the discriminate portion 117. The video signal and the audio signal from the discriminate portion 117 for showing the earthquake alarm detail information are outputted to the video output portion 109 and the audio output portion 110, respectively, so that the earthquake alarming is conducted.

When the discriminate portion 117 determines “earthquake alarm detail information (have no corresponding area)”, it makes no output to the video output portion 109 and the audio output portion 110. However, depending on cases, it may make similar operation to that when “have corresponding area”, thereby to cause the video output portion 109 to display the earthquake detail information of, such as, the area information where strong shock can be forecasted and/or the seismic center information, etc., or t cause the audio output portion 110 to output voices.

When the discriminate portion 117 determines “test signal of earthquake alarm detail information (have corresponding area)”, or “test signal of earthquake alarm detail information (have no corresponding area)”, since this is effective, in general, when confirming the operation on the earthquake alarm information receiver portion 120 in the test mode, and this is neglected in the normal operation mode; therefore, no output is made to the video output portion 109 and the audio output portion 110. When being in the test mode, video information or audio information for indicating a test mode is multiplexed, for example, on the operation of “earthquake alarm detail information (have corresponding area)” or “earthquake alarm detail information (have no corresponding area)”, respectively.

The discriminate portion 117 has a necessity of always confirming the signal discrimination when the earthquake alarm information start/end flag is “have earthquake alarm detail information”, and it confirms the signal discrimination, necessarily, at least when the condition of the earthquake alarm information renewal flag is changed.

Next, in the AC decoder portion 116, the condition exchanging from “have earthquake alarm detail information” to “have no earthquake alarm detail information” is observed with using the earthquake alarm information start/end flag, and when the earthquake alarm information start/end flag changes to “have no earthquake alarm detail information”, the information of “have no earthquake alarm detail information” is transmitted to the controller portion 118. The controller portion 118 transmits a signal for brining the discriminate portion 117 into the stopping condition. Upon reception of this, the discriminate portion 117 shifts into the stopping condition. At the same time, the controller portion 118 transmits a control signal to the broadcast receiver portion 119, and the broadcast receiver portion 119, upon reception of this, keeps the broadcast receiver portion 119 to be in the normal condition only for a predetermined time-period, and also changes the exchanger portion 114 and 115 to the side of the decoder portion 108, so as to output the decoded broadcast video signal and the decoded broadcast audio signal, supplied from the decoder portion 108 for the digital broadcast, being received by the tuner portion 102 at that time, to the video output portion 109 and the audio output portion 110, and after elapsing a predetermined time-period, it brings the broadcast receiver portion 119 into the stopping condition. On the other hand, the controller portion 118 controls the AC decoder portion 116, so as to stop that data output from the AC decoder portion 116 to the discriminate portion 117.

Herein, the stopping condition of the broadcast receiver potion 119 means a condition, wherein the tuner portion 102, the orthogonal modulation portion 103, the FFT portion 104, the synchronization regeneration potion 111 and the frame extractor portion 112 are in the one-segment operation, while the demodulator/decoder portion 105, the descramble portion 106, the demux portion 107, the decoder portion 108, the exchanger portions 114 and 115, the video output portion 109 and the audio output portion 110 do not operate.

The standby condition of the broadcast receiver portion 119 means a condition, wherein the tuner portion 102, the orthogonal modulation portion 103, the FFT portion 104, the synchronization regeneration potion 111 and the frame extractor portion 112 are in 13 segments whole band operation, while the demodulator/decoder portion 105, the descramble portion 106, the demux portion 107 and the decoder portion 108 operate, but the exchanger portions 114 and 115, the video output portion 109 and the audio output portion 110 do not operate.

The normal condition of the broadcast receiver portion 119 means a condition, wherein the tuner portion 102, the orthogonal modulation portion 103, the FFT portion 104, the synchronization regeneration potion 111 and the frame extractor portion 112 are in 13 segments whole band operation, while the demodulator/decoder portion 105, the descramble portion 106, the demux portion 107 and the decoder portion 108 operate, and also the exchanger portions 114 and 115, the video output portion 109 and the audio output portion 110 operate.

However, the TMCC decoder portion 113 is always operating.

The explanation in the above is made upon basis of an assumption of the condition, where the digital broadcast receiver apparatus 121 does not operate; however, the digital broadcast receiver apparatus 121 does the following operations, when it operates, i.e., the broadcast receiver portion 119 is originally in the normal condition.

When the earthquake alarm information start/end flag comes to “have earthquake alarm detail information”, in the AC detector portion 116 is made detection of the condition exchanging from “have no earthquake alarm detail information” to “have earthquake alarm detail information”, and by means of the control signal is transmitted “have earthquake alarm detail information”, i.e., the information that the earthquake alarm information is issued, to the controller portion 118. The controller portion 118 transmits such a control signal that brings the discriminate portion 117 into the normal condition. Also, the controller portion 118 transmits a control signal to the broadcast receiver portion 119, and the broadcast receiver portion 119, upon reception of this, makes preparation for exchanging from the decoded broadcast video signal from the decoder portion 108 to the video signal from the discriminate portion 117, or from the decoded broadcast audio signal from the decoder portion 108 to the audio signal from the discriminate portion 117, to the exchanger portions 114 and 115, respectively. On the other hand, the AC decoder portion 116 outputs data of the earthquake alarm information start/end flag shown in FIG. 5, which is extracted and decided at the time-point when the earthquake alarm information start/end flag comes to “have earthquake alarm detail information”, the earthquake alarm information renewal flag, the discriminate signal, the earthquake alarm detail information, CRC-10 and the parity bits, to the discriminate portion 117.

Within the discriminate portion 117 shifted into the normal condition by the control signal, the error correction is made on the shortened codes of the difference-set cyclic code upon reception of the data from the AC decoder portion 116, and after conducting the error detection of CRC-10, the signal discrimination shown in FIG. 5 is confirmed, so as to discriminate which one of the meanings shown in FIG. 9 it has. And, a predetermined process is conducted, depending on the meaning, respectively, and that discriminate information is transmitted to the controller portion 118.

The controller portion 118 controls the exchanger portions 114 and 115 to select the signal from the discriminate portion 117, when the discriminate signal is “earthquake alarm detail information (has corresponding area)”, upon basis of the determination signal from the discriminate information from the discriminate portion 117. The video signal and the audio signal for showing the earthquake alarm detail information from the discriminate portion 117 are outputted to the video output portion 109 and the audio output portion 110, respectively, and thereby the earthquake alarming is conducted.

Next, in the AC decoder portion 116, the condition exchanging from “have earthquake alarm detail information” to “have no earthquake alarm detail information” is observed with using the earthquake alarm information start/end flag, and when the earthquake alarm information start/end flag changes to “have no earthquake alarm detail information”, the information of “have no earthquake alarm detail information” is transmitted to the controller portion 118. The controller portion 118 transmits a signal for brining the discriminate portion 117 into the stopping condition. Upon reception of this, the discriminate portion 117 shifts into the stopping condition. At the same time, the controller portion 118 transmits a control signal to the broadcast receiver portion 119, and the broadcast receiver portion 119, upon reception of this, conducts exchanging from the decoded broadcast video signal from the decoder portion 108 to the video signal from the discriminate portion 117, or from the decoded broadcast audio signal from the decoder portion 108 to the audio signal from the discriminate portion 117, to the exchanger portions 114 and 115, respectively. On the other hand, the controller portion 118 controls the AC decoder portion 116, so as to stop the data output from the AC decoder portion 116 to the discriminate portion 117.

According to the present embodiment, when the earthquake alarm information is broadcasted, due to the operations of the exchanger portion 114 and 115, since the signals are exchanged from the broadcast video signal and the broadcast audio signal of the normal television broadcast into the video signal and the audio signal of the earthquake alarm information, there can be obtained an effect of providing a digital broadcast receiver apparatus, displaying and outputting pictures and voices of the earthquake alarm information, at the top priority.

Also, since it is sufficient to have only one (1) system of the video output portion and the audio output portion, respectively, there can be obtained an effect of achieving a simple structure and a low price. Furthermore, there can be obtain an effect of enabling to activate the broadcast receiver portion 119, automatically, under the condition that the digital broadcast receiver apparatus 121 does not operate, and an effect of enabling to exchange into the earthquake alarm information, quickly, under the condition that the digital broadcast receiver apparatus 121 operates.

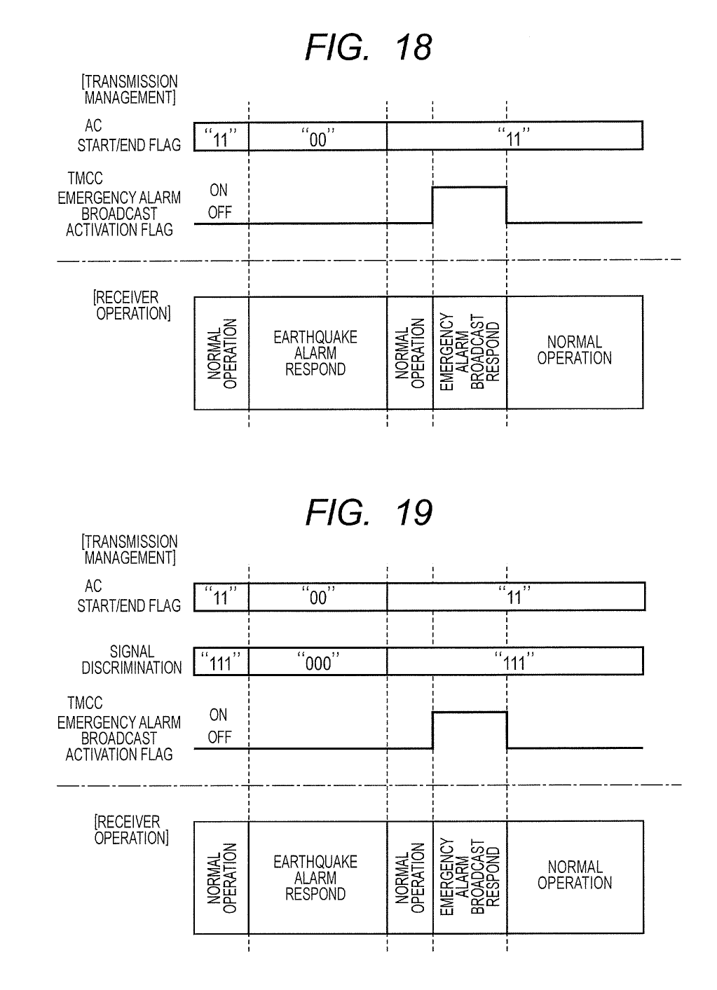

Herein, explanation will be given about the TMCC signal and the AC signal to be transmitted by the digital broadcast transmitter shown in FIG. 2, by referring to FIGS. 18, 19 and 20.

Also, explanation will be given about the TMCC signal and the AC signal to be transmitted by the digital broadcast transmitter shown in FIG. 2, and an operation (a controlling method of the controller portion 118) for receiving the emergency alarm broadcast and the earthquake alarm by the digital broadcast receiver apparatus shown in FIG. 1, for receiving thereof, as well. The controller portion 118, inputting the emergency alarm broadcast activation flag information from the TMCC decoder 113 and/or the earthquake alarm information from the earthquake alarm information receiver portion 120, controls the exchanger portions 114 and 115, at the time when the earthquake alarm should be issued, and thereby causing the video output portion 109 to output the video signal of the earthquake alarm while the audio output portion 110 to output the audio signal of the earthquake alarm.

FIG. 18 shows timing for managing the start/end flag of the earthquake alarm information transmitted by the AC signal and the activation flag for the emergency alarm broadcast transmitted on the TMCC signal. As is shown in FIG. 18, first of all, in case where the start/end flag is “have earthquake alarm detail information: “00””, the activation flag is turned to “have activation control: ON” after the start/end flag comes to “have no earthquake alarm detail information: “11””, without turning the activation flag to “have activation control: ON” during the period of “00”, even if there occurs a necessity of executing the emergency alarm broadcast in that period of “00”. With doing in this manner, for the digital broadcast receiver apparatus being enabled with both the earthquake alarm and the emergency alarm broadcast, there can be obtained an effect of, i.e., avoiding drawbacks caused in receptions, mutually, in the receiving operations of both the earthquake alarm and the emergency alarm broadcast, due to overlapping of the receiving operations of both the earthquake alarm and the emergency alarm broadcast, and also protecting the earthquake alarm information, from being blocked in outputting thereof.

Explanation will be made on the operation of the receiver in this instance.

(1) In case where the start/end flag is “have no earthquake alarm detail information: “11””, and

the activation flag is “have no activation control: OFF”,

then, the receiver conducts the normal operation.

(2) In case where the start/end flag is “have earthquake

alarm detail information: “00””, and

the activation flag is “have no activation control: OFF”,

then, the receiver responds to the earthquake alarm operation.

(3) In case where the start/end flag is “have no earthquake

alarm detail information: “11””, and

the activation flag is “have no activation control: OFF”,

then, the receiver conducts the normal operation.

(4) In case where the start/end flag is “have no earthquake alarm detail information: “11””, and

the activation flag is “have activation control: ON”,

then, the receiver responds to the earthquake alarm operation.

(5) In case where the start/end flag is “have no earthquake alarm detail information: “11””, and

the activation flag is “have no activation control: OFF”,

then, the receiver turns back to the normal operation.

With the operations shown in FIG. 18, since the case that the start/end flag is “have earthquake alarm detail information: “00”” and the case that activation flag for the emergency broadcast pile up, and no transmission is made, then there can be obtain an effect of enabling correspondences to the earthquake alarm operation and the emergency alarm broadcast by the receiver, respectively, without being obstructed.

FIG. 19 shows timing for managing the transmissions of the start/end flag of the earthquake alarm information and the signal discrimination, which are transmitted on the AC signal, and the emergency alarm broadcast activation flag, which is transmitted on the TMCC signal. As is shown in FIG. 19, first of all, in case where the start/end flag is “have earthquake alarm detail information: “00”” and the signal discrimination is “earthquake alarm detail information (have corresponding area): “000””, the activation flag is turned to “have activation control: ON”, after the start/end flag comes to “have no earthquake detail information: “11””, or the signal discrimination comes to “earthquake alarm detail information (have no corresponding area): “001””, without turning the activation flag to “have activation control: ON” during the time-period of “00” or “000”, even if there occurs a necessity of executing the emergency alarm broadcast during that time-period of “00” or “000”. With doing in this manner, for the digital broadcast receiver apparatus being enabled with both the earthquake alarm and the emergency alarm broadcast, there can be obtained an effect of, i.e., avoiding drawbacks caused in receptions, mutually, in the receiving operations of both the earthquake alarm and the emergency alarm broadcast, due to overlapping of the receiving operations of both the earthquake alarm and the emergency alarm broadcast, and also protecting the earthquake alarm information, from being blocked in outputting thereof. However, also in case where the signal discrimination is “test broadcast of earthquake alarm detail information (have corresponding area): “010””, the management follows the case where the signal discrimination is “earthquake alarm detail information (have corresponding area): “000””. However, in this case, “test broadcast of earthquake alarm detail information (have no corresponding area): “011”” in the place of “earthquake alarm detail information (have no corresponding area): “001””.

Explanation will be given about the receiving operation at this time.

(1) In case where:

the start/end flag is “have no earthquake alarm detail information: “11””;

the signal discrimination is “have no earthquake alarm detail information: “111””; and

the activation flag is “have no activation control: OFF”, then

the receiver is in the normal operation.

(2) In case where:

the start/end flag is “have earthquake alarm detail information: “00””;

the signal discrimination is “earthquake alarm detail information (have corresponding area): “000””; and

the activation flag is “have no activation control: OFF”, then

the receiver responds to the earthquake alarm operation.

(3) In case where:

the start/end flag is “have no earthquake alarm detail information: “11””;

the signal discrimination is “have no earthquake alarm detail information: “111””; and

the activation flag is “have no activation control: OFF”, then

the receiver is in the normal operation.

(4) In case where:

the start/end flag is “have no earthquake alarm detail information: “11””;

the signal discrimination is “have no earthquake alarm detail information: “111””; and

the activation flag is “have activation control: ON”, then

the receiver responds to the emergency alarm broadcast.

(5) In case where:

the start/end flag is “have no earthquake alarm detail information: “11””;

the signal discrimination is “have no earthquake alarm detail information: “111””; and

the activation flag is “have no activation control: OFF”, then

the receiver turns back to the normal operation.

In the operation of the receiver shown in FIG. 19, since no transmission is made due to overlapping of the cases where the start/end flag is “have earthquake alarm detail information: “00”” and where the activation flag is “have activation control: ON”, there can be obtained an effect that the receiver can operate corresponding to the earthquake alarm operation and the emergency alarm broadcast, respectively, but without being disturbed.

Or, since no transmission is made when the case where the start/end flag is “have earthquake alarm detail information: “00”” and the signal discrimination is “earthquake alarm detail information (have corresponding area): “00”” overlaps the case where the activation the activation flag is “have activation control: ON”, there can be obtained an effect that the receiver can operate corresponding to the earthquake alarm operation and the emergency alarm broadcast, respectively, but without being disturbed.

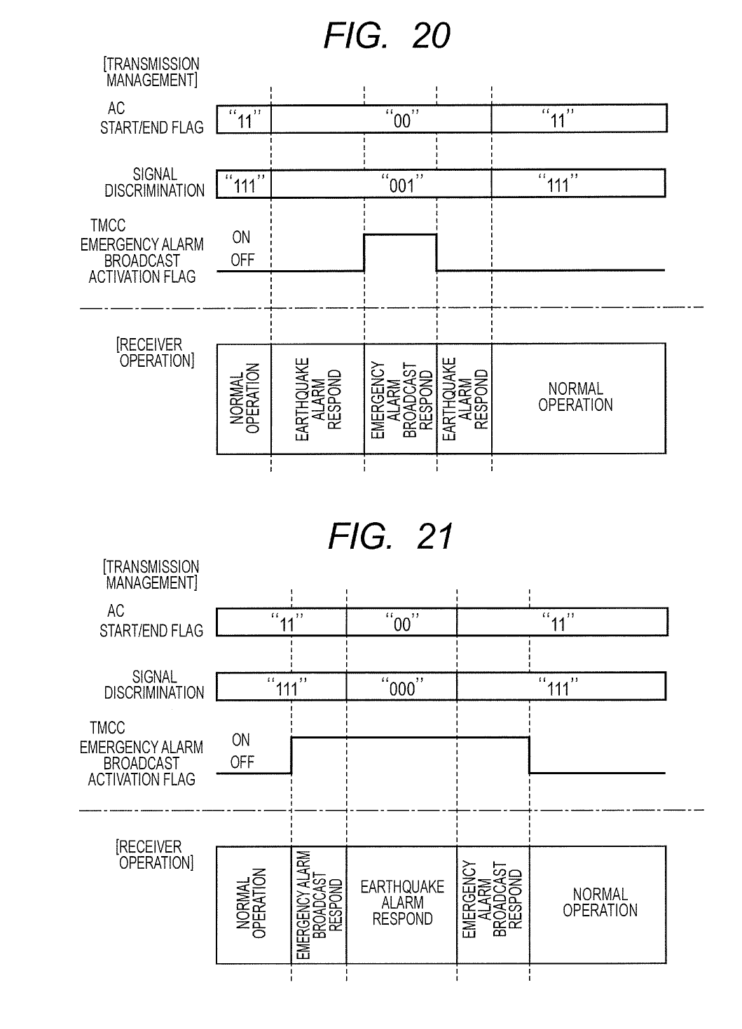

FIG. 20 shows therein the start/end flag of the earthquake alarm information transmitted on the AC signal, the signal discrimination and the activation flag for the emergency alarm broadcast transmitted on the TMCC signal. As is shown in FIG. 20, first of all, in case where the start/end flag is “have earthquake alarm detail information: “00”” and the signal discrimination is “earthquake alarm detail information (have no corresponding area): “001””, and if there occurs necessity of executing the emergency alarm broadcast during the time-period between “00” and “001”, the activation flag is not prevented from being turned to “have activation control: ON” during that time-period. With doing this, there can be obtained an effect of enabling the emergency alarm broadcast as soon as possible. However, also in case where the signal discrimination is “test broadcast of earthquake alarm detail information (have no corresponding area): “011””, the management is made following to the case where the signal discrimination is “earthquake alarm detail information (have no corresponding area): “001””.

First of all, explanation will be made on the operation of the receiver, in case where the activation flag is “have activation control: ON” during the time-period, then the start/end flag turns to “have earthquake alarm detail information: “00””, and further the signal discrimination is “earthquake alarm detail information (have no corresponding area): “001””, and in particular, if there occurs the necessity of starting the emergency alarm broadcast during that time-period, i.e., when the activation flag allows the transmission management of “have activation control: ON” during that time-period.

(1) In case where:

the start/end flag is “have no earthquake alarm detail information: “11””;

the signal discrimination is “have no earthquake alarm detail information: “111””; and

the activation flag is “have no activation control: OFF”, then the receiver is in the normal operation.

(2) In case where:

the start/end flag is “have earthquake alarm detail information: “00””;

the signal discrimination is “earthquake alarm detail information (have no corresponding area): “001””;

the activation flag is “have no activation control: OFF”, then

the receiver responds to the earthquake alarm operation.

(3) In case where:

the start/end flag is “have earthquake alarm detail information: “00””;

the signal discrimination is “earthquake alarm detail information (have no corresponding area): “001””;

the activation flag is “have activation control: ON”, then

the receiver responds to the emergency alarm broadcast.

(4) In case where:

the start/end flag is “have earthquake alarm detail information: “00””;

the signal discrimination is “earthquake alarm detail information (have no corresponding area): “001””; and

the activation flag is “have no activation control: OFF”, then

the receiver responds to the earthquake alarm operation.

(5) In case where:

the start/end flag is “have no earthquake alarm detail information: “11””;

the signal discrimination is “have no earthquake alarm detail information: “111””; and

the activation flag is “have no activation control: OFF”, then

the receiver turns back to the normal operation.

In the operation of the receiver shown in FIG. 20, since the area is not corresponding one of the earthquake alarm in case where the start/end flag is “have earthquake alarm detail information: “00”” and also the signal discrimination is “earthquake alarm detail information (have no corresponding area): “001””, there can be obtained an effect that the emergency alarm broadcast can be made prior to the earthquake alarm operation.

Further, also in case where the signal discrimination is “test broadcast of earthquake alarm detail information (have corresponding area): “010”, the management follows to the case where the signal discrimination is “earthquake alarm detail information (have corresponding area): “000””. Also, where the signal discrimination is “test broadcast of earthquake alarm detail information (have no corresponding area): “011”, the management is made following to the case where the signal discrimination is “earthquake alarm detail information (have no corresponding area): “001””. Since it is the test broadcast, the receiver does not respond to that with the normal operation thereof; however, when being in maintenance, such as, a receiver test mode, etc., the receiver displays a fact that it is the test broadcast, and follows the operation of the receiver in case where the signal discrimination is “earthquake alarm detail information (have corresponding area): “000”” or where the signal discrimination is “earthquake alarm detail information (have no corresponding area): “001””.

Next, explanation will be made in relation to the TMCC signal and the AC signal to be transmitted by the digital broadcast transmitter apparatus shown in FIG. 2, and receiving operations of the emergency alarm broadcast and the earthquake alarm of the digital broadcast receiver apparatus shown in FIG. 1 (i.e., a controlling method of the controller portion 118), being provided for receiving those, by referring to FIGS. 21, 22, 23 and 24.

The controller portion 118, being inputted with the emergency alarm broadcast activation flag information from the TMCC signal and the earthquake alarm information from the earthquake alarm information receiver portion 120, controls the exchanger portions 114 and 115 when the earthquake alarm should be issued, and also outputs the video signal of the earthquake alarm to the video output portion 109 and the audio signal to the audio output portion 110, respectively. Hereinafter, the operation will be explained.

FIG. 21 shows timing for management of the start/end flag of the earthquake alarm information to be transmitted on the AC signal, the signal discrimination, and the emergency alarm broadcast activation flag to be transmitted on the TMCC signal, and the operations for receiving thereof. As is shown in FIG. 21, first of all, when the emergency alarm broadcast starts and the activation flag comes to “have activation control: ON” during the time-period when the start/end flag is “have no earthquake alarm detail information; “11”, and in particular, when there occurs necessity of issuing the earthquake alarm during the time-period of being “have activation control”, the management of the earthquake alarm is started while turning the start/end flag to “have earthquake alarm detail information: “00””, even when the activation flag is “have activation control: ON”. Explanation will be give on the operation of the receiver in this instance.

(1) In case where:

the start/end flag is “have no earthquake alarm detail information: “11””;

the signal discrimination is “have no earthquake alarm detail information: “111””; and

the activation flag is “have no activation control: OFF”, then the receiver is in the normal operation.

(2) In case where:

the start/end flag is “have no earthquake alarm detail information: “11””;

the signal discrimination is “have no earthquake alarm detail information: “111””; and

the activation flag is “have activation control: ON”, then

the receiver responds to the emergency alarm broadcast.

(3) In case where:

the start/end flag is “have earthquake alarm detail information: “00””;

the signal discrimination is “earthquake alarm detail information (have corresponding area): “000””; and

the activation flag is “have activation control: ON”, then

the receiver executes the earthquake alarm operation with priority.

(4) In case where:

the start/end flag is “have no earthquake alarm detail information: “11””;

the signal discrimination is “have no earthquake alarm detail information: “111””; and

the activation flag is “have activation control: ON”, then

the receiver stops the earthquake alarm operation, and responds to the emergency alarm broadcast.

(5) In case where:

the start/end flag is “have no earthquake alarm detail information: “11””;

the signal discrimination is “have no earthquake alarm detail information: “111””; and

the activation flag is “have activation control: OFF”, then

the receiver turns back to the normal operation.

In the operation of the receiver shown in FIG. 21, since the earthquake alarm operation is executed prior to the emergency alarm broadcast, there can be obtain an effect that the earthquake alarm is not disturbed by emergency alarm broadcast.

Also, in case where the start/end flag is “have earthquake alarm detail information: “00” and the signal discrimination is “earthquake alarm detail information (have corresponding area): “000”, since the earthquake alarm operation is executed prior to the emergency alarm broadcast, there can be obtained an effect that an output of the information of the corresponding area of the earthquake alarm is not obstructed by the emergency alarm broadcast.

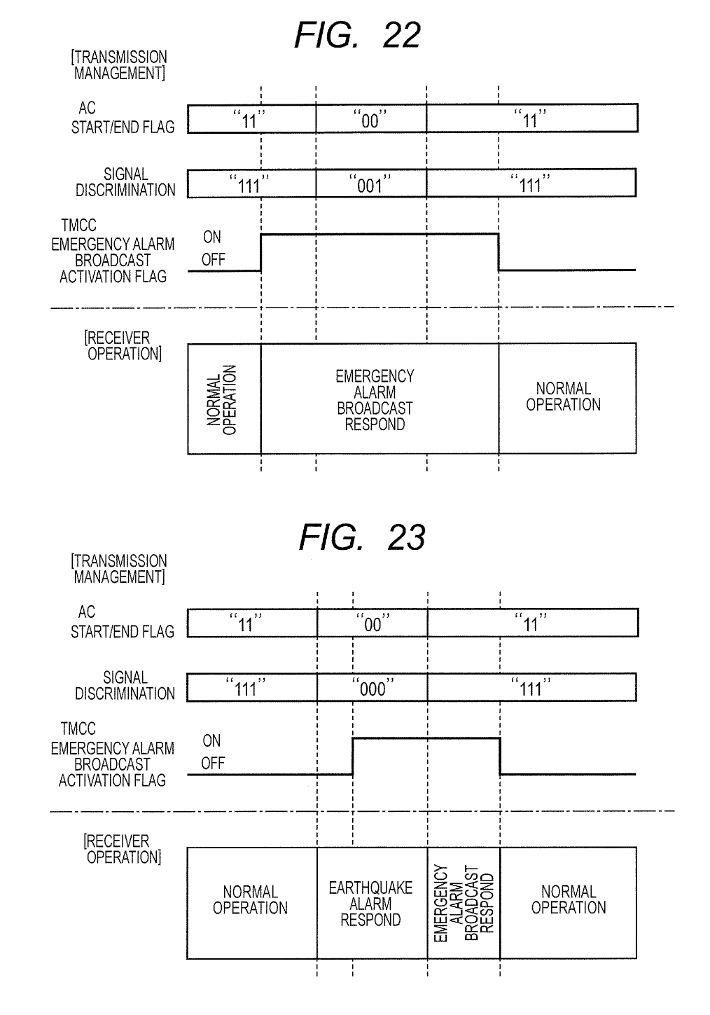

FIG. 22 shows timing for management of the start/end flag of the earthquake alarm information to be transmitted on the AC signal, the signal discrimination, and the emergency alarm broadcast activation flag to be transmitted on the TMCC signal, and the operations for receiving thereof. As is shown in FIG. 22, first of all, when the emergency alarm broadcast starts and the activation flag comes to “have activation control: ON” during the time-period when the start/end flag is “have no earthquake alarm detail information; “11”, and in particular, when there occurs necessity of issuing the earthquake alarm during the time-period of being “have activation control”, the management of the earthquake alarm is started while turning the start/end flag to “have earthquake alarm detail information: “00””, even when the activation flag is “have activation control: ON”. Explanation will be give on the operation of the receiver in this instance, i.e., where the signal discrimination is “earthquake alarm detail information (have no corresponding area): “001””.

(1) In case where:

the start/end flag is “have no earthquake alarm detail information: “11””;

the signal discrimination is “have no earthquake alarm detail information: “111””; and

the activation flag is “have no activation control: OFF”, then

the receiver is in the normal operation.

(2) In case where:

the start/end flag is “have no earthquake alarm detail information: “11””;

the signal discrimination is “have no earthquake alarm detail information: “111””; and

the activation flag is “have activation control: ON”, then

the receiver responds to the emergency alarm broadcast.

(3) In case where:

the start/end flag is “have earthquake alarm detail information: “00””;

the signal discrimination is “earthquake alarm detail information (have no corresponding area): “001””; and

the activation flag is “have activation control: ON”, then

the receiver continues to receive the emergency alarm broadcast.

(4) In case where:

the start/end flag is “have no earthquake alarm detail information: “11””;

the signal discrimination is “have no earthquake alarm detail information: “111””; and

the activation flag is “have activation control: ON”, then

the receiver continues to receive the emergency alarm broadcast.

(5) In case where:

the start/end flag is “have no earthquake alarm detail information: “11””;

the signal discrimination is “have no earthquake alarm detail information: “111””; and

the activation flag is “have activation control: OFF”, then

the receiver turns back to the normal operation.

In the operation of the receiver shown in FIG. 22, since the area is not corresponding one of the earthquake alarm in case where the start/end flag is “have earthquake alarm detail information: “00”” and also the signal discrimination is “earthquake alarm detail information (have no corresponding area): “001””, there can be obtained an effect that the emergency alarm broadcast can be made prior to the earthquake alarm operation.

FIG. 23 shows timing for management of the start/end flag of the earthquake alarm information to be transmitted on the AC signal, the signal discrimination, and the emergency alarm broadcast activation flag to be transmitted on the TMCC signal, and the operations for receiving thereof. As is shown in FIG. 23, first of all, when the earthquake alarm is issued during the time-period when the start/end flag comes to “have earthquake alarm detail information; “00”, and in particular, if there occurs necessity of beginning the emergency alarm broadcast during that time-period of being “have earthquake alarm detail information”, and explanation will be give on the operation of the receiver in case where the activation flag allows the transmission management of “have activation control: ON” during that time-period.

(1) In case where:

the start/end flag is “have no earthquake alarm detail information: “11””;

the signal discrimination is “have no earthquake alarm detail information: “111””; and

the activation flag is “have no activation control: OFF”, then

the receiver is in the normal operation.

(2) In case where:

the start/end flag is “have earthquake alarm detail information: “00””;

the signal discrimination is “earthquake alarm detail information (have corresponding area): “000””; and

the activation flag is “have no activation control: OFF”, then

the receiver responds to the earthquake alarm operation.

(3) In case where:

the start/end flag is “have earthquake alarm detail information: “00””;

the signal discrimination is “earthquake alarm detail information (have corresponding area): “000””; and

the activation flag is “have activation control: ON”, then

the receiver continues the earthquake alarm operation.

(4) In case where:

the start/end flag is “have no earthquake alarm detail information: “11””;

the signal discrimination is “have no earthquake alarm detail information: “111””; and

the activation flag is “have activation control: ON”, then

the receiver responds to the emergency alarm broadcast.

(5) In case where:

the start/end flag is “have no earthquake alarm detail information: “11””;

the signal discrimination is “have no earthquake alarm detail information: “111””; and

the activation flag is “have no activation control: OFF”, then

the receiver turns back to the normal operation.

In the operation of the receiver shown in FIG. 23, since the earthquake alarm operation is executed prior to the emergency alarm broadcast, there can be obtained an effect that the earthquake alarm is not disturbed by the emergency alarm broadcast.

Or, since the earthquake alarm operation is executed prior to the emergency alarm broadcast, in case where the start/end flag is “have earthquake alarm detail information: “00”” and the signal discrimination is “earthquake alarm detail information (have corresponding area): “000””, there can be obtained an effect that an output of the information of the corresponding area of the earthquake alarm is not obstructed by the emergency alarm broadcast.

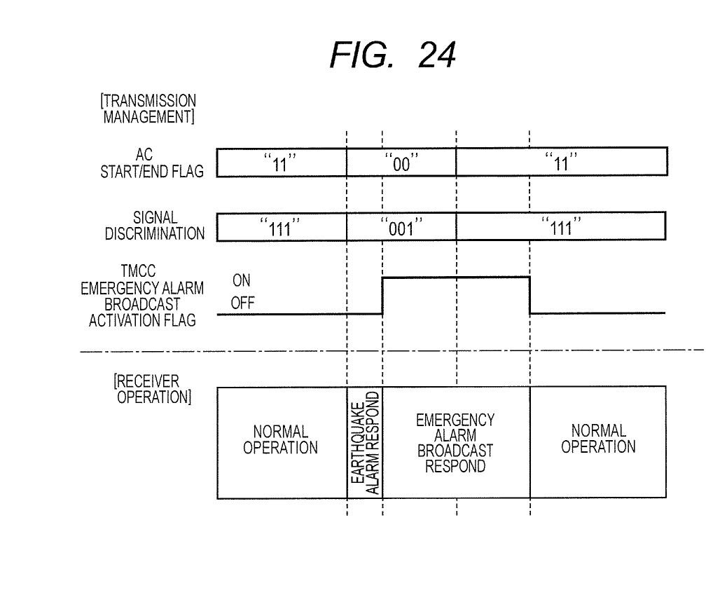

FIG. 24 shows timing for management of the start/end flag of the earthquake alarm information to be transmitted on the AC signal, the signal discrimination, and the emergency alarm broadcast activation flag to be transmitted on the TMCC signal, and the operations for receiving thereof. As is shown in FIG. 24, first of all, when the earthquake alarm is issued during the time-period when the activation flag is “have no activation control: OFF”, the start/end flag comes to “have earthquake alarm detail information; “00”, and the signal discrimination is “earthquake alarm detail information (have no corresponding area): “001”, and in particular, if there occurs necessity of beginning the emergency alarm broadcast during that time-period, and explanation will be give on the operation of the receiver incase where the activation flag allows the transmission management of “have activation control: ON” during that time-period.

(1) In case where:

the start/end flag is “have no earthquake alarm detail information: “11””;

the signal discrimination is “have no earthquake alarm detail information: “111””; and

the activation flag is “have no activation control: OFF”, then

the receiver is in the normal operation.

(2) In case where:

the start/end flag is “have earthquake alarm detail information: “00””;

the signal discrimination is “earthquake alarm detail information (have no corresponding area: “001””; and

the activation flag is “have no activation control: OFF”, then

the receiver responds to the earthquake alarm operation.

(3) In case where:

the start/end flag is “have earthquake alarm detail information: “00””;

the signal discrimination is “earthquake alarm detail information (have no corresponding area: “001””; and

the activation flag is “have activation control: ON”, then

the receiver responds to the emergency alarm broadcast.

(4) In case where:

the start/end flag is “have no earthquake alarm detail information: “11””;

the signal discrimination is “have no earthquake alarm detail information: “111””; and

the activation flag is “have activation control: ON”, then

the receiver responds to the emergency alarm broadcast.

(5) In case where:

the start/end flag is “have no earthquake alarm detail information: “11””;

the signal discrimination is “have no earthquake alarm detail information: “111””; and

the activation flag is “have no activation control: OFF”, then

the receiver turns back to the normal operation.

In the operation of the receiver shown in FIG. 22, since the area is not corresponding one of the earthquake alarm in case where the start/end flag is “have earthquake alarm detail information: “00”” and also the signal discrimination is “earthquake alarm detail information (have no corresponding area): “001””, there can be obtained an effect that the emergency alarm broadcast can be made prior to the earthquake alarm operation.

Further, also in case where the signal discrimination is “test broadcast of earthquake alarm detail information (have corresponding area): “010”, the management follows to the case where the signal discrimination is “earthquake alarm detail information (have corresponding area): “000””. Also, where the signal discrimination is “test broadcast of earthquake alarm detail information (have no corresponding area): “011”, the management is made following to the case where the signal discrimination is “earthquake alarm detail information (have no corresponding area): “001””. Since it is the test broadcast, the receiver does not respond to that with the normal operation thereof; however, when being in maintenance, such as, a receiver test mode, etc., the receiver displays a fact that it is the test broadcast, and follows the operation of the receiver in case where the signal discrimination is “earthquake alarm detail information (have corresponding area): “000”” or where the signal discrimination is “earthquake alarm detail information (have no corresponding area): “001””.

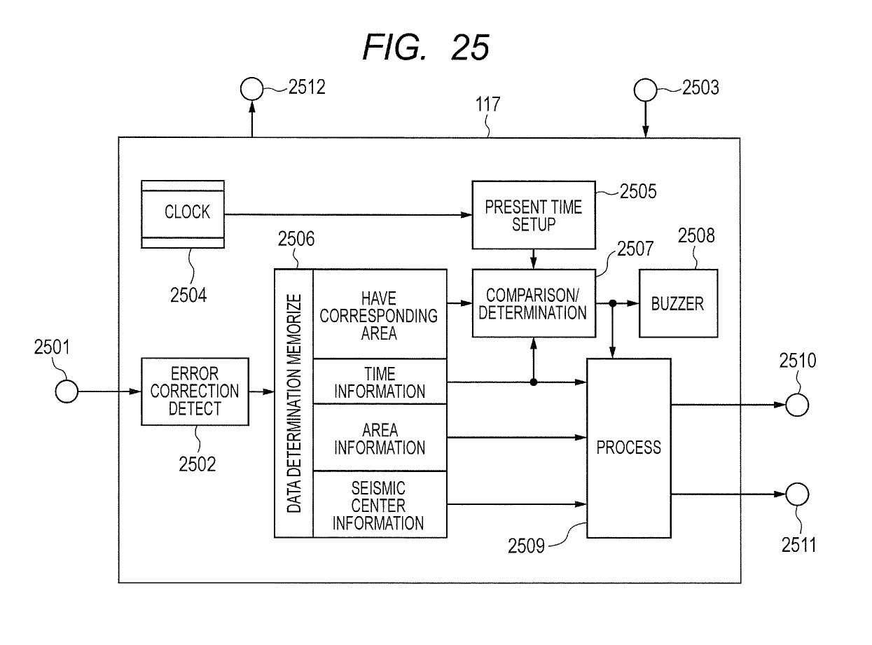

Hereinafter, explanation will be made on an embodiment of the discriminate portion 117, being a principle block of the present invention, by referring to FIG. 25.

A reference numeral 2501 depicts an input of data from the AC decoder portion 116, 2502 an error correction detect portion, 2503 an input of the control signal from the controller portion 118, 2504 a clock portion, 2505 a present time setup portion, 2506 a data determination memory portion, 2507 a comparison/determination portion, 2508 a buzzer sound generator portion, 2509 a processor portion, 2510 an output of video signal, 2511 an output of audio signal, and 2512 an output of determination information to the controller portion 118.

The clock portion 2504 always operates even if the discriminate portion 117 is in the stop condition, and it shows a correct time. As a method for obtaining the correct time may be considered utilization of a GPS (Global Positioning System), utilization of a radio-controlled clock function, i.e., receiving a standard wave for automatically correcting an error, and utilization of a function of automatically renewing the correct time obtained from an outside via the Internet, etc, and the present invention should not be restricted only to those; however, it is undesirable to obtain time information from a digital broadcast because of the reasons, which will be mentioned later.

The present time setup portion 2505, the data determination memory portion 2506, the comparison/determination portion 2507, the buzzer sound generator portion 2508 and the processor portion, 2509 operate when the discriminate portion 117 is in the “standby condition” and the “normal condition”, but not operate when in the “stop condition”.

When the discriminate portion 117 comes into the standby condition or the normal condition upon reception of the control signal from the controller portion 118 via the input 2503, the present time setup portion 2505 always extracts the present time from the clock portion 2504 and sets it up. In case where the AC decoder portion 116 discriminates the earthquake alarm information start/end flag to “have earthquake alarm detail information”, the AC decoder portion 116 transmits the information of “have earthquake alarm detail information” to the controller portion 118. The controller portion 118 transmits the control signal for brining the discriminate portion 117 from the stop condition to the normal condition via the input 2503. Thereafter, upon the control signal from the controller portion 118, via the input portion 2503, from the AC decoder portion 116 to the error correction detect portion 2502 of the discriminate portion 117 are outputted data of the earthquake alarm information start/end flag, the earthquake alarm information renewal flag, the discrimination signal, the earthquake alarm information details, the CRC-10 and the parity bit, which are shown in FIG. 5. The error correction detect portion 2502 conducts the error correction of the shortened codes of the difference-set cyclic code, and thereafter conducts the error correction of CRC-10. If no error can be found, the data from the AC decoder portion 116 is confirmed with the signal discrimination shown in FIG. 5, within the data determination memory portion 2506, to determine, which one of the meanings shown in FIG. 9 it has, and when it is “earthquake alarm detail information (have corresponding area)”, the information shown in FIGS. 10, 11 and 12 are memorized. The time information is memorized, and at the same time, it compared with the present time of the present time setup portion 2505 within the comparison/determination portion 2507. The time information within the data determination memory portion 2506, which is transmitted, is the present time information of the broadcast station when the broadcast station transmits, and has predetermined accuracy. Since there is no chance that shifting of the time information within the data determination memory portion 2506 from the present time of the present time setup portion 2505 comes up to the time obtained by adding process delay on the side of the broadcast station, transmission delay of the broadcasted wave until the time when it reaches the receiver, process delay within the digital broadcast receiver apparatus 121 for receiving this, and the accuracy of the clock portion 2504 to that mentioned above, i.e., to be equal or more than a positive/negative (advance/delay) of the time obtained by adding all of those, at the maximum thereof, the comparison/determination portion 2507, upon basis of this as a threshold value, determines to be “normal” when it lies within the threshold value, while “abnormal” when it exceeds the threshold value. The comparison/determination portion 2507 controls the buzzer sound generator portion 2508 when determining it to be “have corresponding area” and also to be “normal”, and thereby generating the buzzer sound therefrom. With this, even in case of receiving such an attack, i.e., an accumulation is made of the broadcast wave when the earthquake alarm information was issued in the past (hereinafter, being called “RF capture”) and this is transmitted, again, since the RF captured signal has the time information at the time-point when the RF capture was made, the present time of the present time setup portion 2505 is in the condition of exceeding the threshold value, and is determined to be “abnormal” within the comparison/determination portion 2507, so as to make an operation of not generating the buzzer sound, i.e., there can be obtained an effect of enabling to protect the buzzer sound generator portion 2508 from a malfunction of generating the buzzer sound therefrom. However, in the place of the buzzer sound generator portion 2508, the alarm generation may be made by voices or the alarm display may be made by blinking the lights. The determination information within the comparison/determination portion 2507 is transmitted to the processor portion 2509, and also it is transmitted to the controller portion 118 via the output 2512, as well.

The processor portion 2509 controls the earthquake detail information, such as, the time information, the area information including the prefecture or the like, the seismic center information, etc., to be memorized in the data determination memory portion 2506, and at the same time makes preparation of an output from the video signal output 2510 and preparation of an output from the audio signal output 2511. For example, though not shown in FIG. 25, it makes calculation of the time until when the earthquake reaches, from a location where the digital broadcast receiver apparatus is installed, which was memorized in advance, and the earthquake detail information, etc.

From the video signal output 2510 and the audio signal output 2511 are outputted the output signals only when being in the “normal condition”.

When the determination information from the comparison/determination portion 2507 is “normal”, the video signal output 2510 and the audio signal output 2511, upon reception of the signal from the processor portion 2509, output the video signal output and the audio signal output of the earthquake alarm information, respectively. Thus, this includes the earthquake detail information, such as, the area information including the prefecture or the like, and the seismic center information, etc., the time information, or count-down information until the time when the earthquake can be thought to occur.

Within the AC decoder portion 116, an observation is made on the condition of the earthquake alarm information start/end flag changing from “have earthquake alarm detail information” to “have no earthquake alarm detail information”, and when the earthquake alarm information start/end flag comes to “have no earthquake alarm detail information”, the information “have no earthquake alarm detail information” is transmitted to the controller portion 118; then the controller portion 118 sends a signal for brining the discriminate portion 117 into the stop condition, and the discriminate portion 117, upon reception of this via the input 2503, and comes into the stop condition. Thus, all of the blocks, except for the clock portion 2504, stop the operations thereof.

With the embodiment shown in FIG. 25, with conducting the comparison between the time information and the present time, it is possible to prevent an alarm generation from the malfunction thereof.

Further, since generation of the buzzer sound is made therein, there can be obtained an effect of informing the earthquake generation through the buzzer sound as soon as possible.

### Embodiment 2

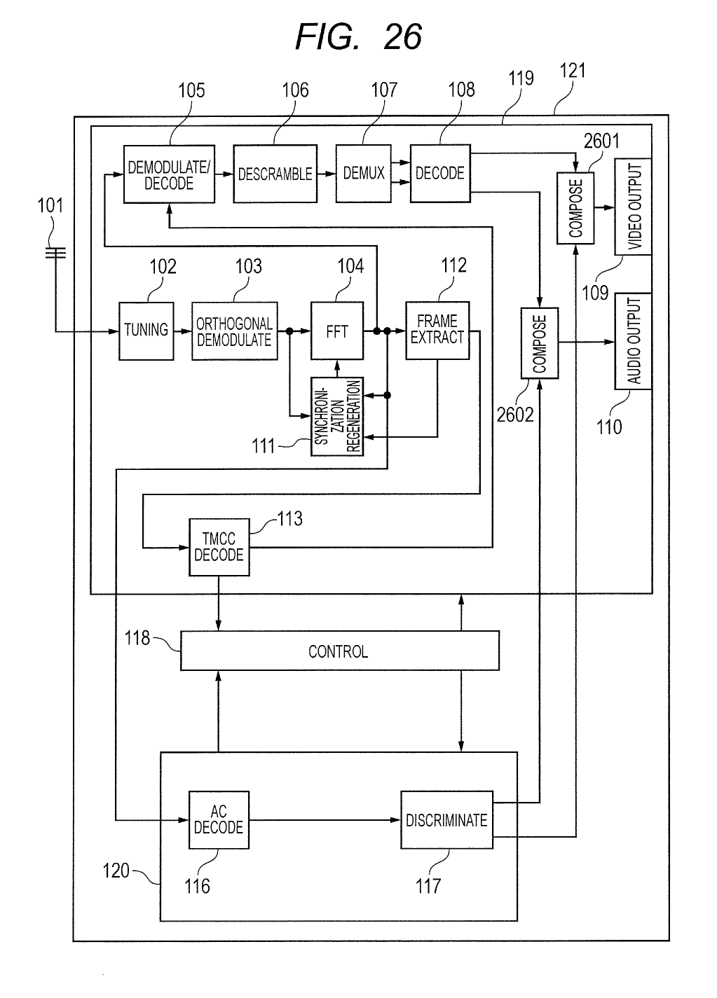

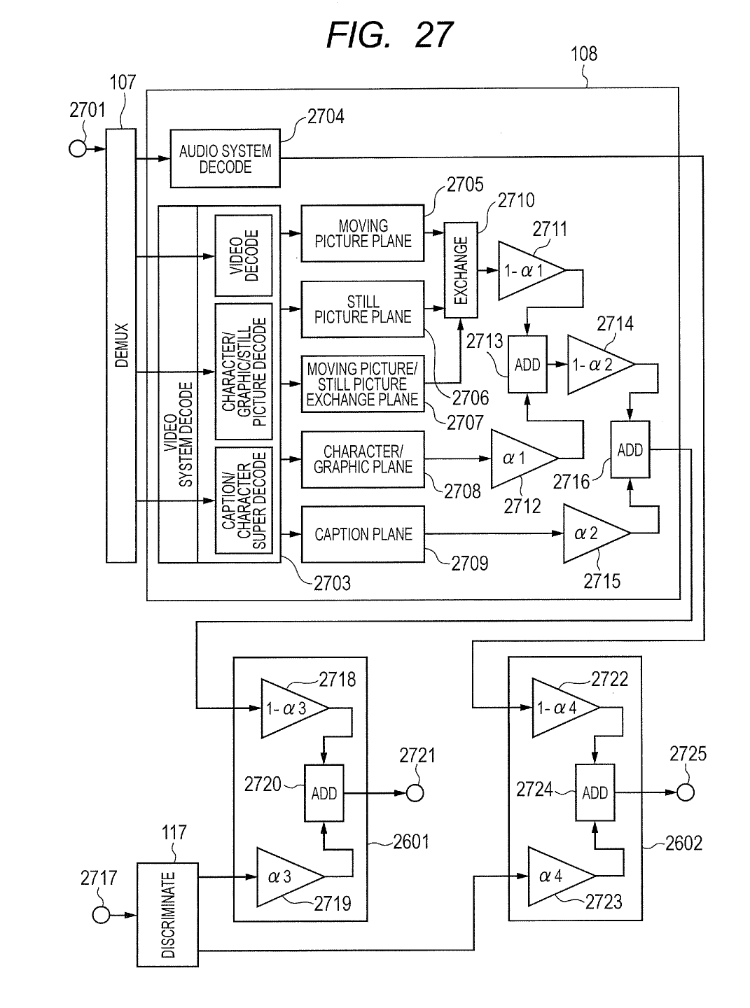

Explanation will be made on an embodiment 2, according to the present invention, by referring to FIGS. 26 and 27.

FIG. 26 is a block diagram for showing the structure of the digital broadcast receiver apparatus for receiving the earthquake alarm information, which is transmitted with using the AC signal included in the segment No. of “#0”, being transmitted by the digital broadcast transmitter apparatus shown in FIG. 2.

Reference numerals 2601 and 2602 depict composer portions, and the details thereof are shown in FIG. 27.

Difference between those shown FIG. 1 and in FIG. 26 lies in that the exchanger portions 114 and 115 are changed into composer portion 2601 and 2602, respectively.

Hereinafter, explanation will be made on the composer portion 2601 and 2602, by referring to FIG. 27. This FIG. 27 also shows the decoder portion 108 in the details thereof.

A reference numeral 2701 depicts an input of digital signal, such as, compressed program video signal and compressed program audio signal from the descramble portion 106, and the data signal, 2703 a video system decoder portion for conducting the decoding process upon the compressed program video data and/or the video system data signals, i.e., the moving picture, the still picture, character/graphic and caption, respectively, 2704 an audio system decoder portion for conducting the decoding process upon the compressed program audio data and/or the audio system data signals, 2705 a moving picture plane display memory for displaying the moving picture thereon, 2706 a still picture plane display memory for displaying the still picture thereon, 2707 a moving picture/still picture exchange plane display memory showing the information for exchanging between the moving picture and the still picture by each pixel thereof, 2708 a character/graphic plane display memory for displaying the character/graphic thereon, 2709 a caption plane display memory for displaying the caption thereon, 2710 an exchanger portion for exchanging between the moving picture from the moving picture plane display memory 2705 and the still picture from the still picture plane display memory 2706, by each pixel thereof, upon basis of the information of the moving picture/still picture exchange plane display memory 2707, 2711 an adjuster portion for adjusting a composition ratio of an output signal of the exchanger portion 2710, 2712 an adjuster portion for adjusting a composition ratio of an output signal of the character/graphic plane display memory 2708, 2713 an adder for composing the output signals of the adjuster portions 2711 and 2712, 2714 an adjuster portion for adjusting a composition ratio of an output of the adder portion 2713, 2715 an adjuster portion for adjusting a composition ratio of an output of the caption plane display memory 2709, 2716 an adder portion for adding output signals of the adjuster portions 2714 and 2715, and those motioned above build up the decoder portion 108. From the adder portion 2716 is outputted the broadcast video signal, and from the audio system decoder portion 2704 is outputted the broadcast audio signal, respectively.

A reference numeral 2717 depicts a data input from the AC decoder portion 116.

A reference numeral 2718 depicts an adjuster portion for adjusting a composition ratio of the broadcast video signal, i.e., the output signal of the adder portion 2716, 2719

an adjuster portion for adjusting a composition ratio of the video signal of the earthquake alarm information, i.e., the output signal of the discriminate portion 117, 2720 an adder portion for composing the output signals of the adjuster portions 2718 and 2719, 2721 an output of composed video signal, i.e., the output signal of the adder portion 2720, and those mentioned above build up the composer portion 2601.

A reference numeral 2722 depicts an adjuster portion for adjusting a composition ratio of the broadcast audio signal, i.e., the output of the audio system decoder portion 2704, 2723 an adjuster portion for adjusting a composition ratio of the audio signal of the earthquake alarm information, i.e., the output of the discriminate portion 117, 2724 an adder portion for composing the output signals of the adjuster portions 2722 and 2723, 2725 an output of a composed audio signal, i.e., the output of the adder portion 2724, and those mentioned above build up the composer portion 2602.

Explanation will be made on a method for composing the broadcast video signal of the decoder portion 108.

The TS signal, which is scrambled for the purpose of copyright protection is descrambled within the descramble portion 106, and is inputted from the input 2701 into the demux portion 107. Within the demux portion 107, the compressed program video signal and the compressed program audio signal, which are desired, and also the data signal are extracted, and are outputted to the decoder portion 108. In this instance, the desired and compressed program video signal and also the video system data signal are inputted into the video system decoder portion 2703, while the desired and compressed program audio signal and also the audio system data signal are inputted into the audio system decoder portion 2704, respectively.

Herein, the desired and compressed program video signal and the video system data signal, and the desired and compressed program audio signal and the audio system data signal are transmitted as a mono-medium, such as, of the character/graphic, the still picture, the moving picture, and the voices, by means of a data stream or a data carousel. Those data are decoded, respectively, to be separated into mono-medium data coded.

The coded mono-medium data is decoded in the respective decoder thereof. Thus, the audio is decoded by audio system decoding, the moving picture by video decoding, the character/graphic/still picture by character/graphic/still picture decoding, the caption/character super by caption/character super decoding, respectively.

Among the video system signals decoded, the character/graphic, the still picture and the moving picture are displayed on the character/graphic plane display memory 2708, the still picture plane display memory 2706 and the moving picture plane display memory 2705, respectively, and they are composed upon the control of the moving picture/still picture exchange plane display memory 2707. However, scaling may be made when it is displayed on each plane.

In a multi-media service, a control for presenting those mono-media is controlled by a framework, which is defined by a multi-media coding. Also, with the caption/super, it is displayed on the caption plane display memory 2709 through a method for coding the caption, or the character/super; the presentation thereof is controlled.

Within the exchanger portion 2710, upon the information of the moving picture/still picture exchange plane display memory 2707, exchange is made between the moving picture from the moving picture plane display memory 2705 and the still picture from the still picture plane display memory 2706, by each pixel thereof. An output signal of the exchanger portion 2710 is adjusted in the adjuster portion 2711, to “1-α1” times in the composition ratio thereof. On the other hand, the character/graphic, i.e., the output signal of the character/graphic plane display memory 2708 is adjusted in the adjuster portion 2712, to “α1” in the composition ratio thereof. Herein, “α1” presents an obscurity, and has a value from “0” to “1”. In the adder portion 2713, the output signals of the adjuster portions 2711 and 2712 are composed with. In case where “α1” is “0”, it comes only the output signal of the exchanger portion 2710, and in case where “α1” is “1”, it comes to only the character/graphic, i.e., the output signal of the character/graphic plane display memory 2708.

The output signal of the adder portion 2713 is adjusted within the adjuster portion 2714, to “1-α2” times in the composition ratio thereof. On the other hand, the character/graphic, i.e., the output signal of the character/graphic plane display memory 2708 is adjusted in the adjuster portion 2715, to “α2” in the composition ratio thereof. Herein, “α2” presents an obscurity, and has a value from “0” to “1”. In the adder portion 2716, the output signals of the adjuster portions 2714 and 2715 are composed with. In case where “α2” is “0”, it comes only the output signal of the exchanger portion 2713, and in case where “α2” is “1”, it comes to only the caption, i.e., the output signal of the caption plane display memory 2709.

As was mentioned above, the caption, the character/graphic, the still picture and the moving picture are composed with, and the broadcast video signal is outputted from the adder portion 2716.

In the composer portion 2601, the broadcast video signal from the adder portion 2716 is adjusted within the adjuster portion 2718, to “1-α3” times in the composition ratio thereof, on the other hand, the video signal of the earthquake alarm information, i.e., the output signal from the discriminate portion 117 is adjusted within the adjuster portion 2719, to “α3” in the composition ratio thereof, and the output signals of the adjuster portions 2718 and 2719 are composed within the adder portion 2720, and the output signal of the adder 2720 is outputted to the output 2721 as the composed video signal. Herein, “α3” presents an obscurity, and has a value from “0” to “1”, and the composed video signal outputted from the output 2721 comes to only the output signal of the broadcast video signal from the adder portion 2716 where “α3” is “0”, while the composed video signal outputted from the output 2721 comes to only the video signal of the earthquake alarm information, i.e., the output signal of the discriminate portion 117, where “α3” is “1”.

In the composer portion 2602,

the broadcast audio signal from the audio system decoder portion 2704 is adjusted within the adjuster portion 2722, to “1-α4” times in the composition ratio thereof, on the other hand, the audio signal of the earthquake alarm information, i.e., the output signal from the discriminate portion 117 is adjusted within the adjuster portion 2723, to “α4” in the composition ratio thereof, and the output signals of the adjuster portions 2722 and 2723 are composed within the adder portion 2724, and the output signal of the adder 2724 is outputted to the output 2721 as the composed audio signal. Herein, “α4” presents the composition ratio, and has a value from “0” to “1”, and the composed audio signal outputted from the output 2725 comes to only the output signal of the broadcast audio signal from the audio system decoder portion 2704 where “α4” is “0”, while the composed audio signal outputted from the output 2725 comes to only the audio signal of the earthquake alarm information, i.e., the output signal of the discriminate portion 117, where “α4” is “1”.

In the present embodiment, by setting “α3” and “α4” to have a value larger than 0.5, there can be obtained an effect of presenting the video signal and/or the audio signal of the earthquake alarm information in remarkable manner, much more than that of the broadcast video signal and/or the broadcast audio signal.

However, the discriminate portion 117 can be constructed in the form of a circuit having no duplicated information in the digital broadcast receiver apparatus 121, if applying character/font information, which the decoder portion 108 has, or display information other than that when producing the video signal of the earthquake alarm information, and in this instance, there can be obtained an effect of enabling a low price discriminate portion 117.

Also, in the embodiment shown in FIG. 26, the controller portion 118 shown in FIGS. 18, 19, 20, 21, 22, 23 and 24, being inputted with the emergency alarm broadcast activation flag information from the TMCC decoder portion 113, and/or the earthquake alarm information from the earthquake alarm information receiver portion 120, can control the composer portions 2601 and 2602 when the earthquake alarm should be issued; thereby causing the video output portion 109 to output the video signal of the earthquake alarm while the audio output portion 110 to output the audio signal of the earthquake alarm.

### Embodiment 3

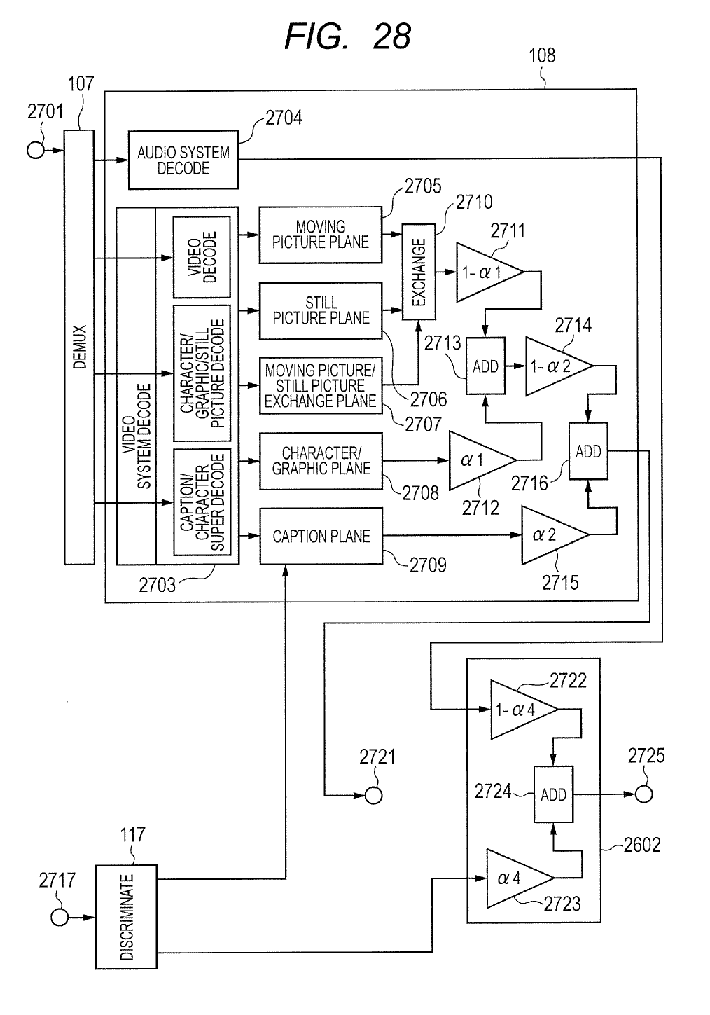

Explanation will be made on an embodiment 3 according to the present invention by referring to FIG. 28.

In FIG. 28 is omitted the composer portion 2601 shown in FIG. 27, and the video signal of the earthquake alarm information is directly written into the caption plane display memory 2709 of the decoder portion 108. The caption plane display memory 2709 renews the video signal of the earthquake alarm information from the discriminate portion 117 after renewing the decoded caption from the video system decoder portion 2703. Or alternately, the caption plane display memory 2709 does not write the decoded caption from the video system decoder portion 2703 into the place where the video signal of the earthquake alarm information from the discriminate portion 117 is written. Or, “α2” is set to a value larger than 0.5.

Further, in case where the caption is displayed on the caption plane display memory 2709, the video signal of the earthquake alarm information can be also displayed avoiding that display portion. Further, the video signal of the earthquake alarm information can be displayed avoiding, not only the caption, but also a display portion, the video display of which is emphasized or necessitated by the broadcaster in a data broadcast. Furthermore, when the receiver displays a video, which is considered to be important by itself, the video signal of the earthquake alarm information can be also displayed avoiding that display portion.

With the above mentioned, there can be obtained an effect of composing the video signal of the earthquake alarm information, to be remarkable much more than the broadcast video signal, to be presented.

However, the discriminate portion 117 can be constructed in the form of a circuit having no duplicated information in the digital broadcast receiver apparatus 121, if applying character/font information, which the decoder portion 108 has, or display information other than that when producing the video signal of the earthquake alarm information, and in this instance, there can be obtained an effect of enabling a low price discriminate portion 117.

### Embodiment 4

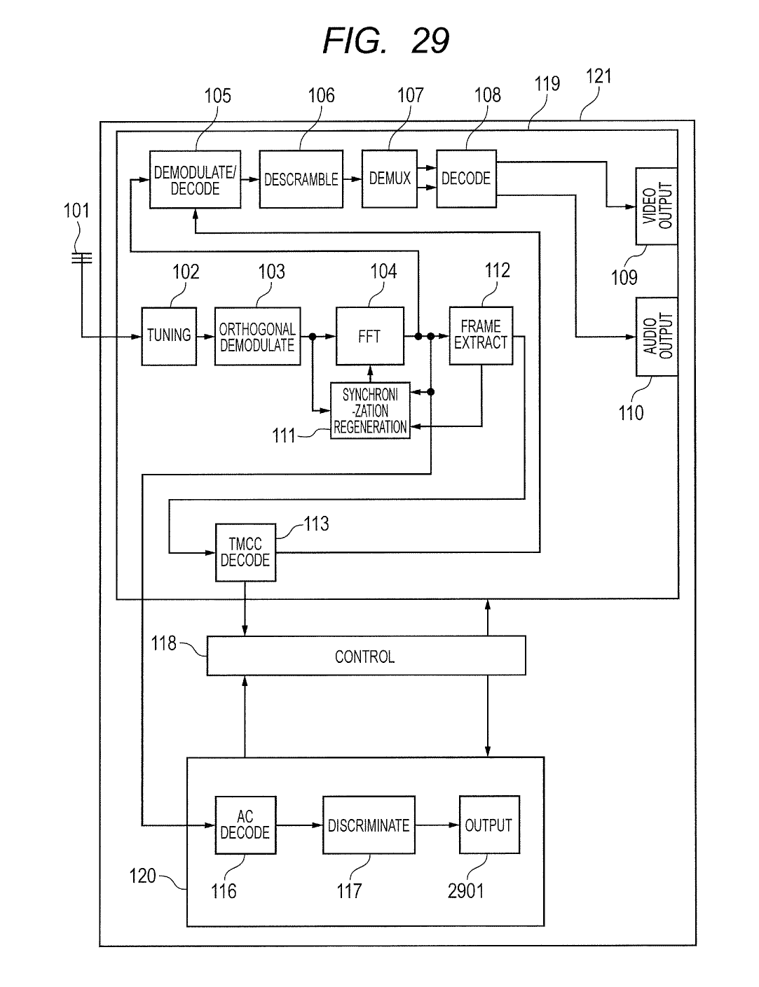

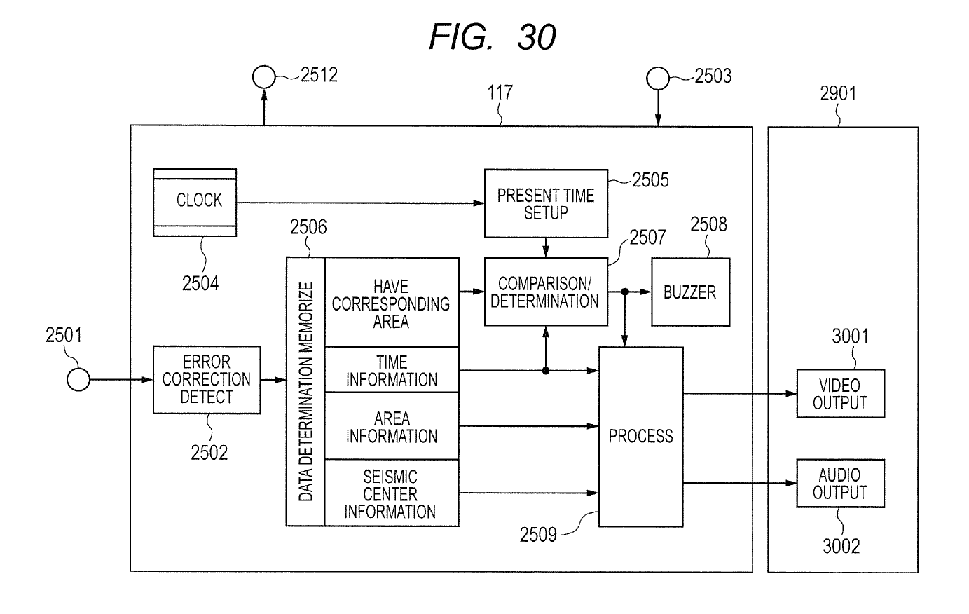

Explanation will be made on an embodiment 4 according to the present invention by referring to FIGS. 29 and 30.

FIG. 29 is a block diagram for showing the structure of the digital broadcast receiver apparatus for receiving the earthquake alarm information, which is transmitted with using the AC signal included in the segment No. of “#0”, being transmitted by the digital broadcast transmitter apparatus shown in FIG. 2.

A reference numeral 2901 depicts an output portion of the earthquake alarm information, and the configuration block diagram thereof will be shown in FIG. 30.

The difference between those shown in FIG. 1 and FIG. 29 lies in that the output 2901 of the earthquake alarm information is separated from the video output portion 109 and the audio output portion 110, i.e., the output portions of the broadcast receiver portion 119.

Also, in FIG. 30, it lies in that the video signal output to be outputted from the video signal output 2510 and the audio signal output to be outputted from the audio signal output 2511 from the processor portion 2509, which are explained in FIG. 25, are outputted with using a video output portion 3001 and an audio output portion 3002, respectively. Further, the video output portion 3001 may be a video display, such as, a flash device of blinking the lights or the like, or a simple video display device, such as, a seven (7) segment display device, for example.

The controller portion 118 shown in FIG. 29, in case where the earthquake alarm information start/end flag turns into “have earthquake alarm detail information” and the discrimination signal is “earthquake alarm detail information (have corresponding area)” due to generation of the earthquake, makes such a control that the outputs from the video output portion 3001 and the audio output portion 3002 of the broadcast receiver portion 119 do not abstract the video signal and the audio signal for showing the earthquake alarm detail information, which are outputted from the video output portion 3001 and the audio output portion 3002, when the video signal and the audio signal, for showing the earthquake alarm detail information, from the discriminate portion 117. In more details, it makes an operation, such as, darkening the video of the video output portion 109, changing to the still picture, outputting a message indicating that the earthquake alarm detail information is issued, or muting (or not outputting) the voices of the audio output portion 110, lowering the sound volume, etc.

With the present embodiment, there can be obtained an effect of making the video signal and the audio signal of the earthquake alarm information remarkable much more than the broadcast video signal and the broadcast audio signal. Also, since having the video output portion and the audio output portion, independent from the broadcast receiver portion, it can bring about an effect of enabling to output the earthquake alarm information, as soon as possible, even under the condition where the video output portion and the audio output portion of the broadcast receiver portion do not output.

Also, in the embodiment shown in FIG. 29, the controller portion 118 shown in FIGS. 18, 19, 20, 21, 22, 23 and 24, being inputted with the emergency alarm broadcast activation flag information from the TMCC decoder portion 113, and/or the earthquake alarm information from the earthquake alarm information receiver portion 120, controls the earthquake alarm to be outputted from the output portion 2901 when the earthquake alarm should be issued; thereby not disturbing the output of the earthquake alarm.

However, the digital broadcast receiver apparatus shown in FIGS. 1, 26 and 29 may be either one of a thirteen (13) segment receiver and a one segment receiver.

### EXPLANATION OF MARKS

101 . . . antenna
102 . . . tuner
103 . . . orthogonal modulator portion
104 . . . high-speed Fourier transformation portion
105 . . . demodulator/decoder portion
106 . . . descramble portion
107 . . . demux portion
108 . . . decoder portion
109 . . . video output portion
110 . . . audio output portion
111 . . . synchronization regeneration potion
112 . . . frame extractor portion
113 . . . TMCC decoder portion
114, 115 . . . exchanger portion
116 . . . AC decoder portion
117 . . . discriminate portion
118 . . . controller portion
119 . . . broadcast receiver portion
120 . . . earthquake alarm information receiver portion
121 . . . digital broadcast receiver apparatus
201 . . . information source coding portion
202 . . . MPEG 2 multiplexer portion
203 . . . TS re-multiplexer portion
204 . . . RS (Reed-Solomon) coding portion
205 . . . hierarchy divider portion
206a,b,c . . . parallel processor portion
207 . . . hierarchy composition portion
208 . . . time interleave portion
209 . . . frequency interleave portion
210 . . . OFDM frame structure portion
211 . . . inverse Fourier transformation portion
212 . . . guard interval adder portion
213 . . . transmitter portion
214 . . . pilot signal composition portion
215 . . . TMCC signal composition portion
216 . . . AC signal composition portion
2501, 2503, 2512 . . . input
2502 . . . error correction detect portion
2504 . . . clock portion
2505 . . . present time setup portion
2506 . . . data determination memory portion
2507 . . . comparison/determination portion
2508 . . . buzzer sound generator portion
2509 . . . processor portion
2510 . . . output of video signal
2511 . . . output of audio signal
2601, 2602 . . . composer portion
2701 . . . input
2703 . . . video system decoder portion
2704 . . . audio system decoder portion
2705 . . . moving picture plane display memory
2706 . . . still picture plane display memory
2707 . . . moving picture/still picture exchange plane display memory
2708 . . . character/graphic plane display memory
2709 . . . caption plane display memory
2710 . . . exchanger portion
2711, 2712, 2714, 2715 . . . adjuster portion
2713, 2716 . . . adder portion
2717 . . . data input
2718, 2719 . . . adjuster portion
2720 . . . adder portion
2721, 2725 . . . output
2722, 2723 . . . adjuster portion
2724 . . . adder portion

What is claimed is:

1. A digital broadcast receiver apparatus for receiving a transmission signal having a digital broadcast signal, including a broadcast video signal or a broadcast audio signal, an emergency alarm broadcast activation flag for indication that an emergency alarm broadcast is activated, a start/end flag for indicating that an earthquake alarm is issued, and an earthquake alarm information signal, being information for showing contents of said earthquake alarm, including signal discrimination information for converting into an earthquake video signal and an earthquake audio signal, comprising:
a receiver portion, which is configured to receive said transmission signal;
a broadcast demodulator portion, which is configured to demodulate said digital broadcast signal from the transmission signal received by said receiver portion;
an emergency alarm broadcast activation flag detector portion, which is configured to detect said emergency alarm broadcast activation flag from the transmission signal received by said receiver portion;
an earthquake alarm information demodulator portion, which is configured to demodulate said earthquake alarm information signal from the transmission signal received by said receiver portion;
an exchanger portion, which is configured to exchange between the broadcast video signal or the broadcast audio signal of the digital broadcast signal, being demodulated in said broadcast demodulator portion, and the earthquake video signal or the earthquake audio signal of the earthquake alarm information signal, being demodulated in said earthquake alarm information demodulator portion; and
a controller portion, which is configured to control said exchanger portion to exchange into said earthquake video signal or said earthquake audio signal, when the start/end flag indicates that the earthquake alarm is issued, the signal discrimination signal indicates that the earthquake alarm has a corresponding area, and further the emergency alarm broadcast activation flag detected in said emergency alarm broadcast activation flag detector portion indicates that the emergency broadcast is activated, among the earthquake alarm information signal, being demodulated in said earthquake alarm information demodulator portion.

2. A digital broadcast receiver apparatus for receiving a transmission signal having a digital broadcast signal, including a broadcast video signal or a broadcast audio signal, an emergency alarm broadcast activation flag for indication that an emergency alarm broadcast is activated, a start/end flag for indicating that an earthquake alarm is issued, and an earthquake alarm information signal, being information for showing contents of said earthquake alarm, including signal discrimination information for converting into an earthquake video signal and an earthquake audio signal, comprising:
a receiver portion, which is configured to receive said transmission signal;
a broadcast demodulator portion, which is configured to demodulate said digital broadcast signal from the transmission signal received by said receiver portion;
an emergency alarm broadcast activation flag detector portion, which is configured to detect said emergency alarm broadcast activation flag from the transmission signal received by said receiver portion;
an earthquake alarm information demodulator portion, which is configured to demodulate said earthquake alarm information signal from the transmission signal received by said receiver portion;
an exchanger portion, which is configured to exchange between the broadcast video signal or the broadcast audio signal of the digital broadcast signal, being demodulated in said broadcast demodulator portion, and the earthquake video signal or the earthquake audio signal of the earthquake alarm information signal, being demodulated in said earthquake alarm information demodulator portion; and
a controller portion, which is configured to control said exchanger portion to exchange into said broadcast video signal or said broadcast audio signal, when the start/end flag indicates that the earthquake alarm is issued, the signal discrimination signal indicates that the earthquake alarm has no corresponding area, and further the emergency alarm broadcast activation flag detected in said emergency alarm broadcast activation flag detector portion indicates that the emergency broadcast is activated, among the earthquake alarm information signal, being demodulated in said earthquake alarm information demodulator portion.

3. A digital broadcast receiving method for receiving a transmission signal having a digital broadcast signal, including a broadcast video signal or a broadcast audio signal, an emergency alarm broadcast activation flag for indication that an emergency alarm broadcast is activated, a start/end flag for indicating that an earthquake alarm is issued, and an earthquake alarm information signal, being information for showing contents of said earthquake alarm, including signal discrimination information for converting into an earthquake video signal and an earthquake audio signal, comprising the following steps of:
a receiving step for receiving said transmission signal;
a broadcast demodulating step for demodulating said digital broadcast signal from the transmission signal received in said receiving step;
an emergency alarm broadcast activation flag detecting step for detecting said emergency alarm broadcast activation flag from the transmission signal received in said receiving step;
an earthquake alarm information demodulating step for demodulating said earthquake alarm information signal from the transmission signal received in said receiving step; and
an exchanging step for exchanging between the broadcast video signal or the broadcast audio signal of the digital broadcast signal, being demodulated in said broadcast demodulating step, and the earthquake video signal or the earthquake audio signal of the earthquake alarm information signal, being demodulated in said earthquake alarm information demodulating step, wherein
exchange is made into said earthquake video signal or said earthquake audio signal, in said exchanging step, when the start/end flag indicates that the earthquake alarm is issued, the signal discrimination signal indicates that the earthquake alarm has a corresponding area, and further the emergency alarm broadcast activation flag detected in said emergency alarm broadcast activation flag detecting step indicates that the emergency broadcast is activated, among the earthquake alarm information signal, being demodulated in said earthquake alarm information demodulating step.

4. A digital broadcast receiving method for receiving a transmission signal having a digital broadcast signal, including a broadcast video signal or a broadcast audio signal, an emergency alarm broadcast activation flag for indication that an emergency alarm broadcast is activated, a start/end flag for indicating that an earthquake alarm is issued, and an earthquake alarm information signal, being information for showing contents of said earthquake alarm, including signal discrimination information for converting into an earthquake video signal and an earthquake audio signal, comprising the following steps of:
a receiving step for receiving said transmission signal;
a broadcast demodulating step for demodulating said digital broadcast signal from the transmission signal received in said receiving step;
an emergency alarm broadcast activation flag detecting step for detecting said emergency alarm broadcast activation flag from the transmission signal received in said receiving step;
an earthquake alarm information demodulating step for demodulating said earthquake alarm information signal from the transmission signal received in said receiving step;
an exchanging step for exchanging between the broadcast video signal or the broadcast audio signal of the digital broadcast signal, being demodulated in said broadcast demodulating step, and the earthquake video signal or the earthquake audio signal of the earthquake alarm information signal, being demodulated in said earthquake alarm information demodulating step; and
exchange is made into said broadcast video signal or said broadcast audio signal, in said exchanging step, when the start/end flag indicates that the earthquake alarm is issued, the signal discrimination signal indicates that the earthquake alarm has no corresponding area, and further the emergency alarm broadcast activation flag detected in said emergency alarm broadcast activation flag detecting step indicates that the emergency broadcast is activated, among the earthquake alarm information signal, being demodulated in said earthquake alarm information demodulating step.
